(19) United States
(12) Patent Application Publication
(10) Pub. No.: US 2025/0015548 A1
(43) Pub. Date: Jan. 9, 2025

(54) RELIABLE HYBRID ELECTRICAL CONNECTOR

(71) Applicant: Amphenol East Asia Electronic Technology (Shenzhen) Co., Ltd., Shenzhen (CN)

(72) Inventors: Danren He, Shenzhen (CN); Zhenbo Liu, Shenzhen (CN)

(73) Assignee: Amphenol East Asia Electronic Technology (Shenzhen) Co., Ltd., Shenzhen (CN)

(21) Appl. No.: 18/761,859

(22) Filed: Jul. 2, 2024

(30) Foreign Application Priority Data
Jul. 7, 2023 (CN) 202310835578.8
Jul. 7, 2023 (CN) 202321787033.6

(51) Int. Cl. H01R 27/02; H01R 13/52; H01R 43/00

(52) U.S. Cl. CPC H01R 27/02; H01R 13/5208; H01R 43/005

(57) ABSTRACT

A reliable hybrid electrical connector. The connector includes power and signal modules disposed in a space at least partially enclosed by a housing, with first ends facing housing rear and second ends extending out of housing bottom. Power and signal cables are attached to the first ends of the power and signal modules, respectively, and extend out of the housing rear through a rear cap. The rear cap has a cavity with a first sealing member therein forming a seal around the power and signal cables. A cover is disposed at a top of the housing with a second sealing member around the cover and between the cover and the housing. A third sealing member is disposed between a hoop disposed around a sheath of the power cable and the power module. The housing further includes portions protruding outwardly and configured for securing the connector on another component.

### CROSS-REFERENCE TO RELATED APPLICATIONS

This application claims priority to and the benefit of Chinese Patent Application Serial No. 202321787033.6, filed on Jul. 7, 2023. This application also claims priority to and the benefit of Chinese Patent Application Serial No. 202310835578.8, filed on Jul. 7, 2023. The entire contents of these applications are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those use to communicate data over an automobile network.

### BRIEF SUMMARY

Aspects of the present disclosure relate to reliable hybrid electrical connectors, which may be economically assembled to both provide high signal integrity and supply reliable power in a harsh environment such as one presented by an automobile.

Some embodiments relate to an electrical connector. The electrical connector may comprise a housing at least partially enclosing a space, the housing comprising an opening, connected to the space, at a top and a cap disposed at a rear of the housing, the cap comprising a cavity having first and second channels connected to the space; a first cable extending through the first channel of the cap into the space of the housing; a second cable extending through the second channel of the cap into the space of the housing; and a sealing material disposed in the cavity of the cap such that portions of the first and second cables extending through the first and second channels are fixedly disposed in the sealing material.

Optionally, the electrical connector may comprise a first module comprising a first end disposed in the space and connected to the first cable, and a second end extending out of the housing from a bottom of the housing and configured to mount to a circuit board; and a second module comprising a first end disposed in the space and connected to the second cable, and a second end extending out of the housing from the bottom of the housing and configured to mount to a circuit board.

Optionally, the first module is a power module configured to supply power; and the second module is a signal module configured to transmit Ethernet signals.

Optionally, the cap comprises a bottom having grooves and protrusions protruding into the cavity and engaging the sealing material.

Optionally, the electrical connector may comprise a cover disposed at the top of the housing and substantially covering the opening at the top of the housing, wherein the sealing material comprises a first portion disposed around the cover so as to fill a groove between the cover and the housing.

Optionally, the cover is separated from the cap by a first portion of the space of the housing; the sealing material comprises a second portion disposed in the first portion of the space of the housing; and portions of the first and second cables extending in the first portion of the space pass through and are held by the second portion of the sealing material.

Optionally, the housing comprises a rib; the first portion of the space of the housing is between the rear of the housing and the rib; the space of the housing comprises a second portion between the rib and a front of the housing; the electrical connector comprises one or more modules disposed in the second portion of the space; and each of the one or more modules is a terminal subassembly.

Optionally, the first cable comprises a sheath and a plurality of wires in the sheath, each of the plurality of wires comprising an end extending out of the sheath; the first module is connected to the first cable at the end extending out of the sheath; the housing comprises a chamber through which the ends of the plurality of wires extend to the first module; and the sealing material comprises a third portion disposed in the chamber of the housing such that the ends of the plurality of wires of the first cable are fixedly disposed in the third portion.

Optionally, the sealing material comprises cured adhesive.

Optionally, the electrical connector may comprise a hoop disposed adjacent the chamber of the housing and attached to the sheath of the first cable.

Some embodiments relate to an electrical connector. The electrical connector may comprise a housing comprising an opening at a rear and a plurality of attachment portions extending outwardly from a front and/or sides; a first module disposed in the housing, the first module comprising a plurality of first ends extending toward the rear of the housing and a plurality of second ends extending out of a bottom of the housing; and a second module disposed in the housing, the second module comprising a plurality of first ends extending toward the rear of the housing and a plurality of second ends extending out of the bottom of the housing.

Optionally, each of the plurality of attachment portions of the housing comprises a hole extending therethrough.

Optionally, the plurality of attachment portions of the housing comprises a first pair of attachment portions extending outwardly from the front of the housing, and a second pair of attachment portions respectively extending outwardly from opposite sides of the housing.

Optionally, the electrical connector may comprise a first cable attached to the plurality of first ends of the first module and extending out of the housing from the rear of the housing; and a second cable attached to the plurality of first ends of the second module and extending out of the housing from the rear of the housing, the second cable comprising a pair of signal wires.

Optionally, the rear of the housing comprises a cap having a cavity through which the first and second cables extend; and the electrical connector comprises a sealing member disposed in the cavity of the cap and enclosing portions of the first and second cables extending therein.

Optionally, the electrical connector may comprise a cover disposed at a top of the housing; and a second sealing member disposed between the housing and the cover.

Optionally, the first cable comprises two or more wires; a hoop disposed around a sheath of the first cable; and a third sealing member disposed between the first module and the hoop.

Some embodiments relate to a method of manufacturing an electrical connector. The method may comprise providing a subassembly comprising a first module and a second module, a rear cap of a housing, and first and second cables extending through the rear cap of the housing into the housing, the rear cap of the housing comprising a cavity; providing adhesive into the cavity of the rear cap and around portions of the first and second cables extending through the cavity of the rear cap of the housing so as to form a seal between the housing and the first and second cables; positioning the first module and the second module in the housing; and affixing the rear cap to the housing.

Optionally, the method may comprise providing adhesive into a chamber inside the housing and around portions of wires of the first cable so as to form a seal between the housing and the first cable.

Optionally, the method may comprise disposing a cover at a top of the housing; and providing adhesive around the cover and in gaps between the cover and the housing so as to form a seal between the housing and the cover.

Some embodiments relate to an electrical connector. The electrical connector may include a housing comprising a plurality of walls enclosing a space, a first wall of the plurality of walls comprising a cavity formed therein, a first channel extending from the cavity through a rear portion of the first wall to an exterior of the housing, and a second channel extending from the cavity through a front portion of the first wall to the space; a module at least partially disposed in the space; a cable extending into the space from the exterior of the housing through the first channel, the cavity, and the second channel of the first wall, and connected to the module at an end thereof; and a first glue filled in the cavity and disposed around a portion of the cable located in the cavity to fix the cable relative to the first wall.

Optionally, the housing comprises at least: a body, the space located within the body, and the body comprising a rear end and a rear opening connecting to the space at the rear end; and a rear cap mounted to the rear end of the body to close the rear opening, the first wall of the housing formed by the rear cap.

Optionally, the front portion of the first wall comprises a front face facing towards the space and a slot extending from the front face through the front portion to the cavity, and a portion of the rear end of the body is inserted into the slot and the first glue engages with the portion of the rear end.

Optionally, the portion of the rear end of the body comprises a first surface exposed in the cavity and a protrusion protruding into the cavity from the first surface, and the first glue is disposed onto the first surface and engages with the protrusion.

Optionally, the protrusion is configured as a barb.

Optionally, the portion of the rear end of the body comprises a first surface exposed in the cavity and a recess recessed into the portion from the first surface, and the first glue is disposed onto the first surface and is filled into the recess.

Optionally, the portion of the cable located in the cavity extends in a first direction, and the first wall comprises an opening extending from the exterior of the housing through a side portion of the first wall to the cavity in a second direction perpendicular to the first direction to allow the first glue to be filled into the cavity via the opening.

Optionally, the rear portion and the front portion of the first wall are opposing to and spaced apart from each other by the cavity in the first direction, and the side portion connects the rear portion and the front portion.

Optionally, the front portion of the first wall comprises a front face facing towards the space and a slot extending into the cavity from the front face through the front portion, a portion of the rear end of the body is inserted into the slot and comprises a first surface exposed in the cavity on a side of the portion of the cable facing away from the opening, and the first glue is disposed onto the first surface and engages with the first surface.

Optionally, the first wall further comprises a bottom portion, the bottom portion and the side portion are opposing to and spaced apart from each other by the cavity in the second direction, the bottom portion comprises a top face facing towards the dispensing chamber and a groove recessed into the bottom portion from the top face and connecting to the slot, and the portion of the rear end of the body is inserted into the groove through the slot and the first surface is flush with the top face.

Optionally, the portion of the rear end of the body further comprises a protrusion protruding into the cavity from the first surface, and the first glue is disposed onto the first surface and engages with the protrusion.

Optionally, the portion of the rear end of the body further comprises a recess recessed into the portion from the first surface, and the first glue is disposed onto the first surface and filled into the recess.

Optionally, the first channel and the second channel are aligned with each other in the first direction, and a cross-section of the cavity perpendicular to the first direction is larger than a cross-section of the first channel perpendicular to the first direction and is larger than a cross-section of the second channel perpendicular to the first direction.

Optionally, the body further comprises a front end opposite to the rear end, a first side between the rear end and the front end, a top opening communicating the space with the exterior of the housing at the first side, and an edge portion defining the top opening; the housing further comprises a top cover comprising a top face, a bottom face opposite to the top face, a side face extending between the top face and the bottom face, and a flange extending outwardly beyond the side face, the flange comprising a top face and a bottom face opposite to the top face, the top face is lower than the top face; the top cover is disposed in the top opening of the body to close the top opening with the bottom face and the bottom face facing towards the space; the edge portion of the body forms a groove together with the side face and the top face of the top cover, and the electrical connector further comprises a second glue filled in the groove to provide a seal.

Optionally, the body further comprises a flange protruding into the top opening, and the bottom face of the flange of the top cover is supported on the flange.

Optionally, the body comprises a bottom wall opposing to the top opening and a rib protruding into the space from the bottom wall, the rib divides the space into a first space between the rear end and the rib and a second space between the rib and the front end, the module is located in the second space and the cable extends into the second space from the exterior of the housing through the first wall and the first space, the top cover is disposed over the second space to separate the second space from the exterior of the housing, and the top cover engages with the rib and, together with the rib, separates the second space from the first space, and the electrical connector further comprises a third glue filled in the first space to provide a seal.

Optionally, the groove extends to and communicates with the first space to allow the second glue and the third glue to be applied integrally.

Optionally, the top cover further comprises a rear flange extending downwardly towards the rib from the bottom face or the flange, and the rear flange engages with the rib, and a passageway is formed at engaging portions of the rear flange and the rib, and the cable extends into the second space through the passageway.

Optionally, the cable comprises a first cable comprising a wire and a sheath surrounding the wire, a portion of the sheath at an end of the first cable is removed to allow the wire to extend beyond an end of the sheath, the end of the sheath is located in the space, and the electrical connector further comprises a fourth glue disposed in the space around the end of the sheath and forming a seal at the end of the sheath.

Optionally, the housing comprises a chamber formed around the end of the sheath in the space, and the fourth glue is filled in the chamber.

Optionally, the electrical connector further comprises a hoop mounted on the sheath of the first cable and fixing the first cable in the space.

Optionally, the hoop comprises an annular body mounted on the sheath and a tab protruding outwardly from the annular body, the housing comprises a receiving area formed in the accommodating cavity, the tab is received in the receiving area to fix the first cable in the accommodating cavity.

Optionally, the first cable is a power cable configured for transmitting power.

Some embodiments relate to an electrical connector. The electrical connector may include a housing, comprising: a body comprising a plurality of walls enclosing a space, an opening communicating the space with an exterior of the housing at a first side of the body, and an edge portion defining the opening; and a top cover comprising a top face, a bottom face opposite to the top face, a side face extending between the top face and the bottom face, and a flange extending outwardly beyond the side face, the flange comprising a top face and a bottom face opposite to the top face, the top face lower than the top face; a module at least partially disposed in the space; and a cable extending into the space from the exterior of the housing through a first wall of the plurality of walls, and connected to the module at an end thereof. The top cover is disposed in the opening of the body to close the opening, with the bottom face and the bottom face facing towards the space, and with the edge portion of the body forming a groove together with the side face and the top face of the top cover. The electrical connector further comprises a first glue filled in the groove to form a seal.

Optionally, the body further comprises a flange protruding into the opening and the bottom face of the flange of the top cover is supported on the flange.

Optionally, the plurality of walls further comprises a second wall opposing to the first wall and a bottom wall extending between the first wall and the second wall, the bottom wall is opposing to the opening; the body further comprises a rib extending into the space from the bottom wall, the rib divides the space into a first space between the first wall and the rib and a second space between the rib and the second wall; the module is located in the second space and the cable extends into the second space from the exterior of the housing through the first wall and the first space; the top cover is disposed over the second space to separate the second space from the exterior of the housing, and the top cover engages with the rib and, together with the rib, separates the second space from the first space; and the electrical connector further comprises a second glue filled in the first space to provide a seal.

Optionally, the groove extends into and communicates with the first space to allow the first glue and the second glue to be applied integrally.

Optionally, the top cover further comprises a rear flange extending downwardly towards the rib from the bottom face or the flange, and the rear flange engages with the rib, and a passageway is formed at engaging portions of the rear flange and the rib, and the cable extends into the second space through the passageway.

Optionally, the cable comprises a first cable comprising a wire and a sheath surrounding the wire, a portion of the sheath at an end of the first cable is removed to allow the wire to extend beyond an end of the sheath, the end of the sheath is located in the space;

and the electrical connector further comprises a third glue disposed in the space around the end of the sheath and forming a seal at the end of the sheath.

Optionally, the electrical connector further comprises a hoop mounted on the sheath of the first cable and fixing the first cable in the space.

Optionally, the first cable is a power cable configured for transmitting power.

Optionally, the first wall comprises a cavity formed in the first wall, a first channel extending from the cavity through a rear portion of the first wall to an exterior of the housing, and a second channel extending from the cavity through a front portion of the first wall to the space; the cable extends into the space from the exterior of the housing through the first channel, the cavity, and the second channel of the first wall; and a fourth glue filled in the cavity and disposed around a portion of the cable located in the cavity to fix the cable relative to the first wall.

Some embodiments relate to an electrical connector. The electrical connector may include a housing comprising a plurality of walls enclosing a space; a module at least partially disposed in the space; a cable extending into the space from an exterior of the housing through a first wall of the plurality of walls and connected to the module at an end thereof, the cable comprising a wire and a sheath surrounding the wire, a portion of the sheath at the end of the cable is removed to allow the wire to extend beyond an end of the sheath, the end of the sheath is located in the space; and a first glue disposed in the space around the end of the sheath and forming a seal at the end of the sheath.

Optionally, the housing comprises a chamber formed around the end of the sheath in the space, and the first glue is filled in the chamber.

Optionally, the cable is a power cable configured for transmitting power.

Optionally, the electrical connector further comprises a hoop mounted on the sheath of the cable and fixing the cable in the space.

Optionally, the hoop comprises an annular body mounted on the sheath and a tab protruding outwardly from the annular body, the housing comprises a receiving area formed in the accommodating cavity, the tab is received in the receiving area to fix the cable in the accommodating cavity.

Optionally, the cable comprises a power cable configured for transmitting power and a signal cable configured for transmitting a signal; the module comprises a power module configured for transmitting power and a signal module configured for transmitting a signal; and the power cable is connected to the power module and the signal cable is connected to the signal module.

Optionally, the signal cable is configured for transmitting an Ethernet electrical signal.

Optionally, portions of the power cable and the signal cable extending outside of the housing are surrounded by the same jacket.

Optionally, the module comprises a conductive terminal comprising a first end and a second end opposite to the first end, the first end is connected to the cable, and the second end is configured to be mounted to a circuit board.

Optionally, the housing further comprises an attachment portion protruding outwardly, and a hole formed in the attachment portion.

Some embodiments relate to a method for manufacturing an electrical connector. The method may include providing a housing comprising a plurality of walls enclosing a space, a first wall of the plurality of walls comprising a cavity formed therein, a first channel extending from the cavity through a rear portion of the first wall to an exterior of the housing, and a second channel extending from the cavity through a front portion of the first wall to the space; disposing a module at least partially in the space; extending a cable into the space from the exterior of the housing through the first channel, the cavity, and the second channel of the first wall, and connecting the cable to the module at an end thereof; and filling a first glue in the cavity and disposing the first glue around a portion of the cable located in the cavity to fix the cable relative to the first wall.

Optionally, the housing comprises at least a body and a rear cap, the space is located within the body, and the body comprises a rear end and a rear opening connecting to the space at the rear end, the rear cap is configured to form the first wall of the housing; and the method further comprises mounting the rear cap to the rear end of the body to close the rear opening.

Optionally, the front portion of the first wall comprises a front face facing towards the space and a slot extending from the front face through the front portion to the cavity; and the method further comprises inserting a portion of the rear end of the body into the slot and bringing the first glue into engagement with the portion of the rear end.

Optionally, the portion of the rear end of the body comprises a first surface exposed in the cavity and a protrusion protruding into the cavity from the first surface; and bringing the first glue into engagement with the portion of the rear end comprises disposing the first glue onto the first surface and into engagement with the protrusion.

Optionally, the portion of the rear end of the body comprises a first surface exposed in the cavity and a recess recessed into the portion from the first surface; and bringing the first glue into engagement with the portion of the rear end comprises disposing the first glue onto the first surface and filling the first glue into the recess.

Optionally, the portion of the cable located in the cavity extends in a first direction, the first wall comprises an opening extending from the exterior of the housing through a side portion of the first wall to the cavity in a second direction perpendicular to the first direction to allow the first glue to be filled into the cavity via the opening; and filling the first glue in the cavity comprises filling the first glue into the cavity via the opening.

Optionally, the rear portion and the front portion of the first wall are opposing to and spaced apart from each other by the cavity in the first direction, and the side portion connects the rear portion and the front portion; the front portion of the first wall comprises a front face facing towards the space and a slot extending to the cavity from the front face through the front portion; and the method further comprises: inserting a portion of the rear end of the body into the slot such that a first surface of the portion is exposed in the cavity on a side of the portion of the cable facing away from the opening; and disposing the first glue onto the first surface and into engagement with the first surface.

Optionally, the first wall further comprises a bottom portion, the bottom portion and the side portion are opposing to and spaced apart from each other by the cavity in the second direction; the bottom portion comprising a top face facing towards the dispensing chamber and a groove recessed into the bottom portion from the top face and connecting to the slot; and inserting the portion of the rear end of the body into the slot comprises inserting the portion of the rear end of the body into the groove through the slot with the first surface flush with the top face.

Optionally, the portion of the rear end of the body further comprises a protrusion protruding into the cavity from the first surface, and disposing the first glue onto the first surface and into engagement with the first surface comprises disposing the first glue onto the first surface and into engagement with the protrusion.

Optionally, the portion of the rear end of the body further comprises a recess recessed into the portion from the first surface, and disposing the first glue onto the first surface and into engagement with the first surface comprises disposing the first glue onto the first surface and filling the first glue into the recess.

Optionally, the body further comprises a front end opposite to the rear end, a first side between the rear end and the front end, a top opening communicating the space with the exterior of the housing at the first side, and an edge portion defining the top opening; and the housing further comprises a top cover comprising a top face, a bottom face opposite to the top face, a side face extending between the top face and the bottom face, and a flange extending outwardly beyond the side face, the flange comprises a top face and a bottom face opposite to the top face, the top face is lower than the top face; the method further comprises: disposing the top cover in the top opening of the body to close the top opening with the bottom face and the bottom face facing towards the space and with the edge portion of the body forming a groove together with the side face and the top face of the top cover; and filling a second glue in the groove to provide a seal.

Optionally, the body further comprises a flange protruding into the top opening; and disposing the top cover in the top opening comprises disposing the bottom face of the flange of the top cover on the flange.

Optionally, the body comprises a bottom wall opposing to the top opening and a rib protruding into the space from the bottom wall, the rib divides the space into a first space between the rear end and the rib and a second space between the rib and the front end; the module is located in the second space, and the cable extends into the second space from the exterior of the housing through the first wall and the first space; the top cover is disposed over the second space to separate the second space from the exterior of the housing, and the top cover engages with the rib and, together with the rib, separates the second space from the first space; and the method further comprises filling a third glue in the first space to provide a seal.

Optionally, the groove extends to and communicates with the first space to allow the second glue and the third glue to be applied integrally; and the method further comprises applying the second glue and the third glue integrally.

Optionally, the cable comprises a first cable comprising a wire and a sheath surrounding the wire; the method further comprises: removing a portion of the sheath at an end of the first cable to allow the wire to extend beyond an end of the sheath, wherein the end of the sheath is located in the space; and disposing a fourth glue in the space around the end of the sheath to form a seal at the end of the sheath.

Optionally, before disposing the fourth glue, mounting a hoop onto the sheath of the first cable and fix the first cable in the space with the hoop.

Optionally, the first cable is a power cable configured for transmitting power.

Some embodiments relate to a method for manufacturing an electrical connector. The method may include providing a housing, comprising: a body comprising a plurality of walls enclosing a space, an opening communicating the space with an exterior of the housing at a first side of the body, and an edge portion defining the opening; and a top cover comprising a top face, a bottom face opposite to the top face, a side face extending between the top face and the bottom face, and a flange extending outwardly beyond the side face, the flange comprising a top face and a bottom face opposite to the top face, the top face lower than the top face; disposing a module at least partially in the space; extending a cable into the space from the exterior of the housing through a first wall of the plurality of walls, and connecting the cable to the module at an end thereof; disposing the top cover in the opening of the body to close the opening, with the bottom face and the bottom face facing towards the space, and with the edge portion of the body forming a groove together with the side face and the top face of the top cover; and filling a first glue in the groove to form a seal.

Optionally, the body further comprises a flange protruding into the opening; and disposing the top cover in the opening comprises disposing the bottom face of the flange of the top cover on the flange.

Optionally, the plurality of walls further comprises a second wall opposing to the first wall and a bottom wall extending between the first wall and the second wall, the bottom wall is opposing to the opening; the body further comprises a rib extending into the space from the bottom wall, the rib divides the space into a first space between the first wall and the rib and a second space between the rib and the second wall; the module is located in the second space and the cable extends into the second space from the exterior of the housing through the first wall and the first space; the top cover is disposed over the second space to separate the second space from the exterior of the housing, and the top cover engages with the rib and, together with the rib, separates the second space from the first space; and the method further comprises filling a second glue in the first space to provide a seal.

Optionally, the groove extends to and communicates with the first space to allow the first glue and the second glue to be applied integrally; and the method further comprises applying the first glue and the second glue integrally.

Optionally, the cable comprises a first cable comprising a wire and a sheath surrounding the wire; the method further comprises: removing a portion of the sheath at an end of the first cable to allow the wire to extend beyond an end of the sheath, wherein the end of the sheath is located in the space; and disposing a third glue in the space around the end of the sheath to form a seal at the end of the sheath.

Optionally, before applying the third glue, mounting a hoop onto the sheath of the first cable and fixing the first cable in the space with the hoop.

Optionally, the first cable is a power cable configured for transmitting power.

Optionally, the first wall comprises a cavity formed in the first wall, a first channel extending from the cavity through a rear portion of the first wall to an exterior of the housing, and a second channel extending from the cavity through a front portion of the first wall to the space; extending the cable into the space from the exterior of the housing through the first wall comprises extending the cable into the space from the exterior of the housing through the first channel, the cavity, and the second channel of the first wall; and the method further comprises filling a fourth glue in the cavity and disposing the fourth glue around a portion of the cable located in the cavity to fix the cable relative to the first wall.

Some embodiments relate to a method for manufacturing an electrical connector. The method may include providing a housing comprising a plurality of walls enclosing a space; disposing a module at least partially in the space; extending a cable extending into the space from an exterior of the housing through a first wall of the plurality of walls, and connecting the cable to the module at an end thereof, wherein the cable comprises a wire and a sheath surrounding the wire, a portion of the sheath at the end of the cable is removed to allow the wire to extend beyond an end of the sheath, the end of the sheath is located in the space; and disposing a first glue in the space around the end of the sheath to form a seal at the end of the sheath.

Optionally, before applying the first glue, mounting a hoop onto the sheath of the cable and fixing the cable in the space with the hoop.

Optionally, the cable is a power cable configured for transmitting power.

These techniques may be used alone or in any suitable combination. The foregoing summary is provided by way of illustration and is not intended to be limiting.

### BRIEF DESCRIPTION OF DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a top perspective view of a hybrid electrical connector, according to some embodiments;

FIG. 2 is a bottom perspective view of the electrical connector of FIG. 1;

FIG. 3 is an exploded view of the electrical connector of FIG. 1;

FIG. 4 is a perspective view of the electrical connector of FIG. 1, with a top cover of a housing, a first glue, a second glue, a third glue, a fourth glue, and a hoop hidden;

FIG. 5 is a partially exploded view of the electrical connector of FIG. 4;

FIG. 6 is a perspective view of the electrical connector of FIG. 4, with a cable hidden;

FIG. 7 is a perspective view of the electrical connector of FIG. 1, with the top cover of the housing, the second glue, and the third glue hidden;

FIG. 8 is an enlarged view of the area A circled by the dashed lines in FIG. 4;

FIG. 9 is an enlarged view of the area B circled by the dashed lines in FIG. 7;

FIG. 10 is a perspective view of a hoop of the electrical connector of FIG. 1;

FIG. 11 is a perspective view of the cable of the electrical connector of FIG. 1;

FIG. 12 is a perspective view of the electrical connector of FIG. 1, with the second glue and the third glue hidden;

FIG. 13 is a partial cross-sectional view of the electrical connector taken along line I-I in FIG. 1;

FIG. 14 is a perspective view of the rear cap of the electrical connector of FIG. 1;

FIG. 15 is a top perspective view of the top cover of the electrical connector of FIG. 1; and

FIG. 16 is a bottom perspective view of the top cover of the electrical connector shown in FIG. 15.

### LIST OF REFERENCE NUMBERS

X-X longitudinal direction
Y-Y lateral direction
Z-Z vertical direction
1 electrical connector
10 housing
11 space
11a first space
11b second space
12 attachment portion
13 hole
20 module
21 power module
21a body of the power module
21b second end of the power terminal of the power module
22 signal module
22a body of the signal module
22b second end of the signal terminal of the signal module
30 cable
31 power cable
31a end of the power cable
33 wire of the power cable
33a conductor of the wire of the power cable
33b insulator of the wire of the power cable
34 sheath of the power cable
34a end of the sheath of the power cable
32 signal cable
32a end of the signal cable
35 wire of the signal cable
35a conductor of the wire of the signal cable
35b insulator of the wire of the signal cable
36 sheath of the signal cable
36a end of the sheath of the signal cable
41 first glue
42 second glue
43 third glue
44 fourth glue
50 jacket
60 groove
70 passageway
100 body
101 rear end
101a a portion of the rear end
101b first surface of the portion 101a of the rear end
101c protrusion
101d recess
102 front end
103 first sidewall
103a edge portion of the first sidewall
104 second sidewall
104a edge portion of the second sidewall
105 third sidewall
105a edge portion of the third sidewall
106 bottom wall
107 rear opening
108 top opening
109 latch
120 flange
130 rib
140 chamber
150 receiving area
200 rear cap
200a cavity
200b opening
201 rear portion
202 front portion
202a front face of the front portion
203 side portion
204 bottom portion
204a top face of the bottom portion
204b groove of the bottom portion
210 first channel
220 second channel
300 top cover
301 top face
302 bottom face
303 side face
304 flange
304a top face
304b bottom face
304c side face
305 rear flange
400 hoop
401 annular body
402 tab.

### DETAILED DESCRIPTION

The inventors have recognized and appreciated techniques for making a hybrid connector, which can be economically assembled to both provide high signal integrity and supply reliable power in a harsh environment such as one presented by an automobile. The connector may be configured to provide power and signal interconnections for applications such as automotive LiDAR. The connector may be compatible with related standards such as USCAR-2 and TC9.

In some embodiments, an electrical connector may include a housing at least partially enclosing a space, and power and signal modules disposed in the space of the housing. In some embodiments, each of the power and signal module may have first ends facing a rear of the housing and second ends extending out of a bottom of the housing.

In some embodiments, power and signal cables may be attached to the first ends of the power and signal modules, respectively, and extend out of the rear of housing through a cap. The cap may have a cavity with a first sealing member disposed therein and around portions of the power and signal cables extending in the cavity of the cap. The first sealing member may be formed by filling a first adhesive into the cavity so as to both seal the rear of the housing and restrain movements of the portions of the power and signal cables extending the cavity of the cap. The adhesive may be flexibly shaped according to the shape of the cavity and therefore may ensure a reliable seal, despite variations in shape of the parts to be scaled, such as might result from manufacturing tolerance.

In some embodiments, a cover may be disposed at a top of the housing. A second sealing member may be disposed around the cover and between the cover and the housing. The second sealing member may be formed by filling a second adhesive around the cover and in any gaps between the cover and the housing. There may be a space between the cover and the rear cap of the housing. The second sealing member may have portions disposed in that space. The second sealing member may surround and be adhered to portions of the first and second cables that pass through the space between the cover and the rear cap of the housing. Such a second sealing member may both seal any gaps between the cover and the housing and also restrain movements of portions of the power and signal cables extending through the space between the cover and the rear cap of the housing. The adhesive may be flexibly shaped according to the shape of these gaps and spaces and therefore yield a robust connector resistant to environmental conditions despite manufacturing tolerance.

In some embodiments, a third sealing member may be disposed between a hoop disposed around a sheath of the power cable and the power module. A portion of the sheath of the power cable may be removed so as to attach wires of the power cable to the power module. The third sealing member may seal any gap between the sheath of the power cable and the power cable, serving as an insulative layer around the exposed wires, and restrains movements of the exposed wires.

In some embodiments, the housing may include portions protruding outwardly and configured for securing the connector on another component. Each portion may have a hole, through which a screw may extend for holding the portion to another component.

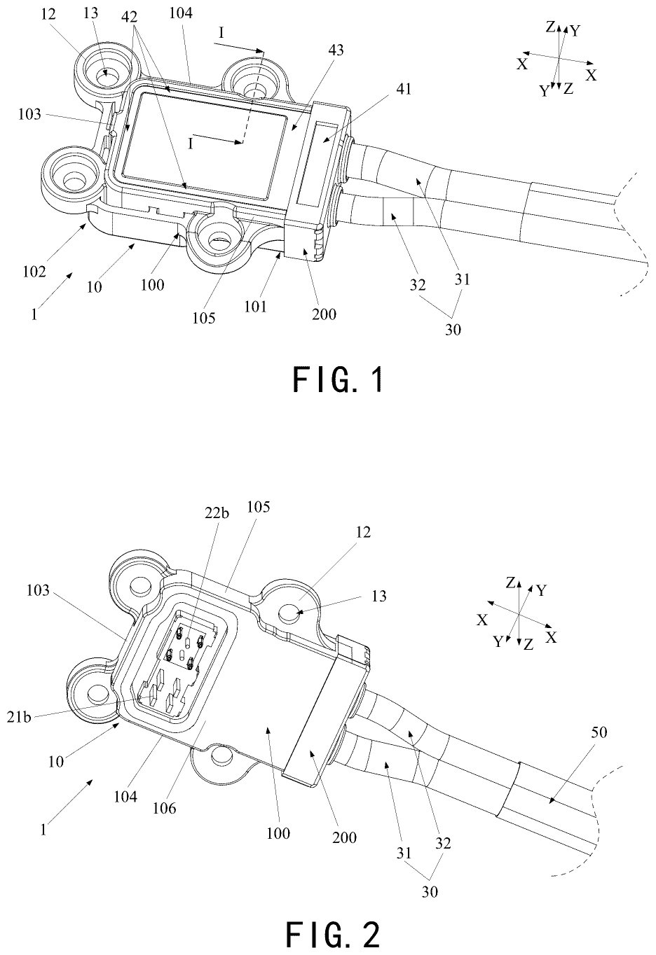

FIGS. 1 to 16 illustrate an electrical connector 1 according to some embodiments of the present application. The electrical connector 1 may be a hybrid connector to provide both power and signal interconnections. In some examples, the electrical connector 1 may be a connector used to provide both power and Ethernet signal interconnections to, for example, an automotive LIDAR. The electrical connector 1 may be compatible with standards such as USCAR-2 and TC9. It should be appreciated that the electrical connector 1 may be used in any suitable application.

For the sake of clarity and conciseness of the description, a longitudinal direction X-X, a lateral direction Y-Y, and a vertical direction Z-Z may be defined. The longitudinal direction X-X, the lateral direction Y-Y, and the vertical direction Z-Z may be perpendicular to each other. The longitudinal direction X-X may refer to the length direction of the electrical connector 1, the lateral direction Y-Y may refer to the width direction of the electrical connector 1, and the vertical direction Z-Z may refer to the height direction of the electrical connector 1. It should be appreciated that aspects of the present application are not intended to be limited by these directions.

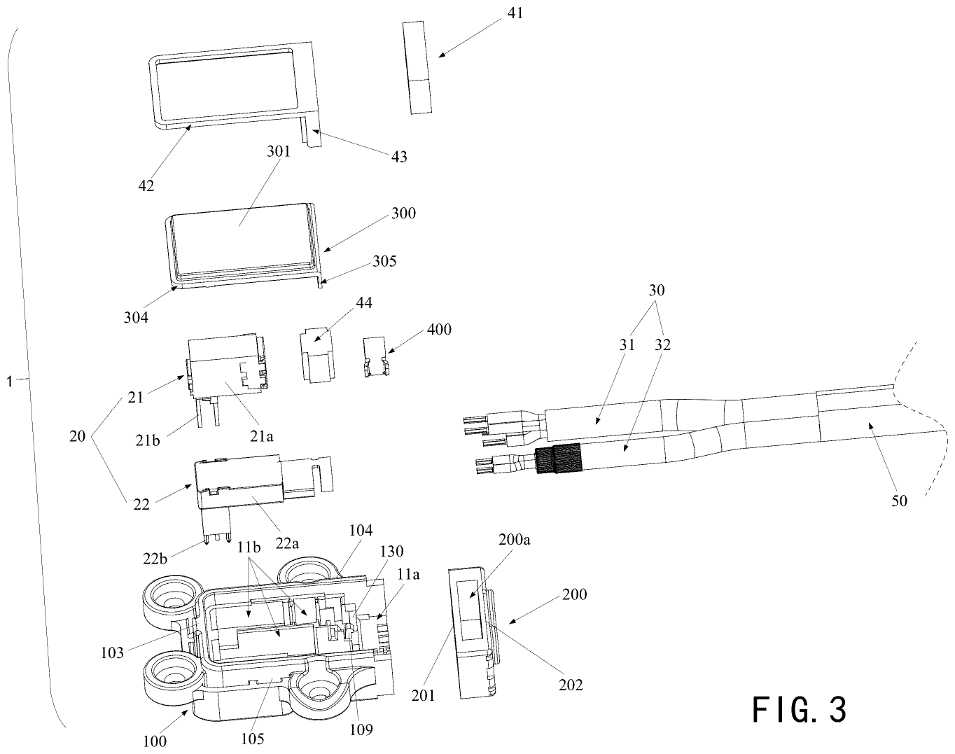

FIG. 1 is a top perspective view illustrating the electrical connector 1, FIG. 2 is a bottom perspective view illustrating the electrical connector 1, and FIG. 3 is an exploded view illustrating the electrical connector 1.

As shown in FIGS. 1 to 3, the electrical connector 1 includes a housing 10, a module 20 at least partially disposed in the housing 10, and a cable 30 extending into the housing 10 from an exterior of the housing 10 and connected to the module 20. It should be appreciated that only a portion of the cable 30 is shown in the figures.

In some embodiments, the cable 30 may include a power cable 31 configured for transmitting power and a signal cable 32 configured for transmitting signals. The signal cable 32 may be configured for transmitting Ethernet electrical signals. The module 20 may include a power module 21 configured for transmitting power and a signal module 22 configured for transmitting signals. The power cable 31 is connected to the power module 21 and the signal cable 32 is connected to the signal module 22.

In some embodiments, the housing 10 may include a body 100 and a rear cap 200 and a top cover 300 mounted to the body 100. In some embodiments, the housing 10 may also include a hoop 400 mounted in the body 100 to secure the cable (the hoop 400 is shown to secure the power cable 31).

In some embodiments, as shown in FIGS. 1 and 3, the electrical connector 1 may include a first glue (or adhesive) 41, a second glue (or adhesive) 42, a third glue (or adhesive) 43, and a fourth glue (or adhesive) 44. The glues (or adhesives) may also be referred to as “glue members (or adhesive members).”

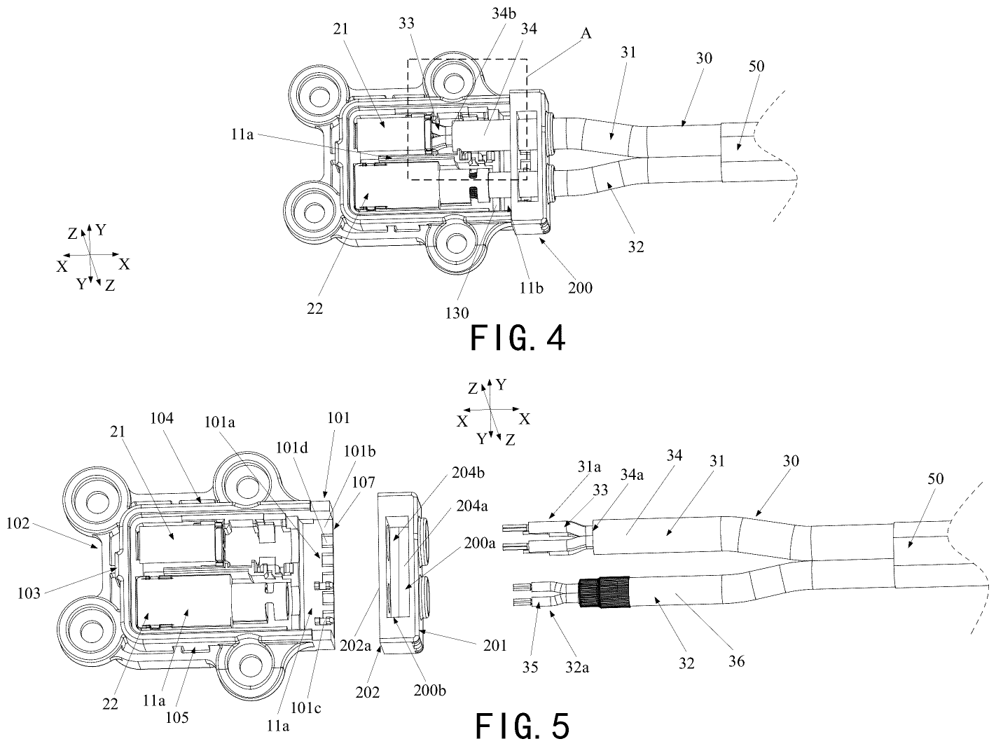

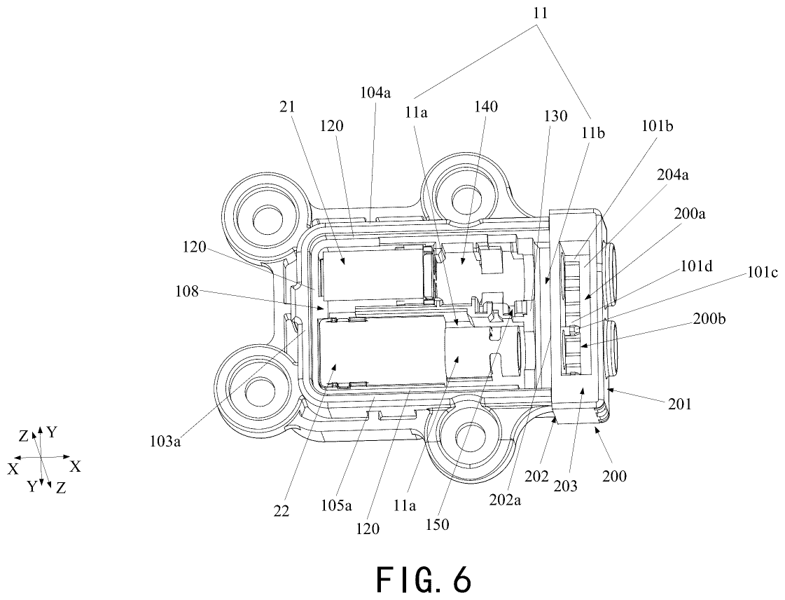

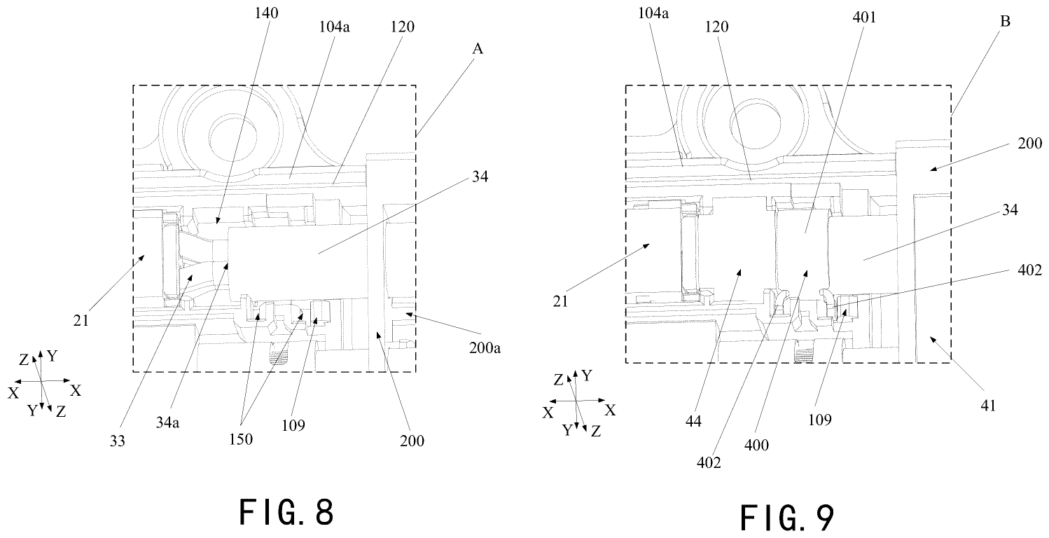

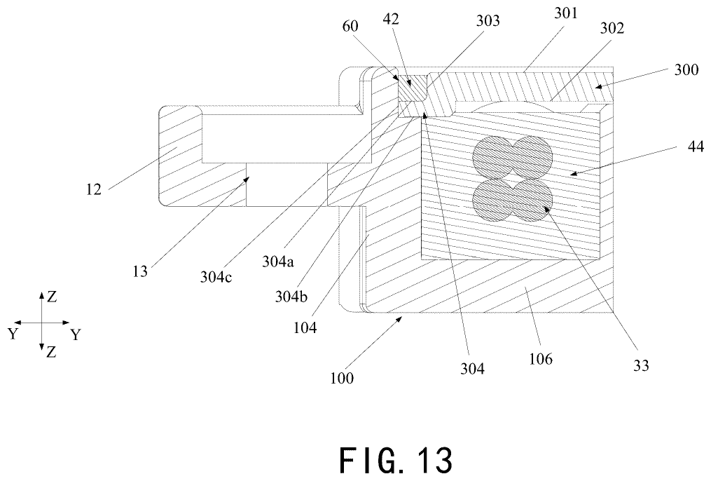

FIG. 4 is a perspective view of the electrical connector 1 of FIG. 1 with the top cover 300 of the housing 10, the first glue 41, the second glue 42, the third glue 43, the fourth glue 44, and the hoop 400 of the electrical connector 1 hidden. FIG. 5 is a partially exploded view of the electrical connector 1 of FIG. 4, in which the cable 30 and the rear cap 200 have not yet been mounted to the body 100, and the module 20 is mounted to the body 100. FIG. 6 is a perspective view similar to FIG. 4, with the cable 30 of the electrical connector 1 hidden. FIG. 8 is an enlarged view of the area A circled by dashed lines in FIG. 4. FIG. 11 is a perspective view of the cable 30. FIG. 13 is a partial cross-sectional view taken along line I-I in FIG. 1.

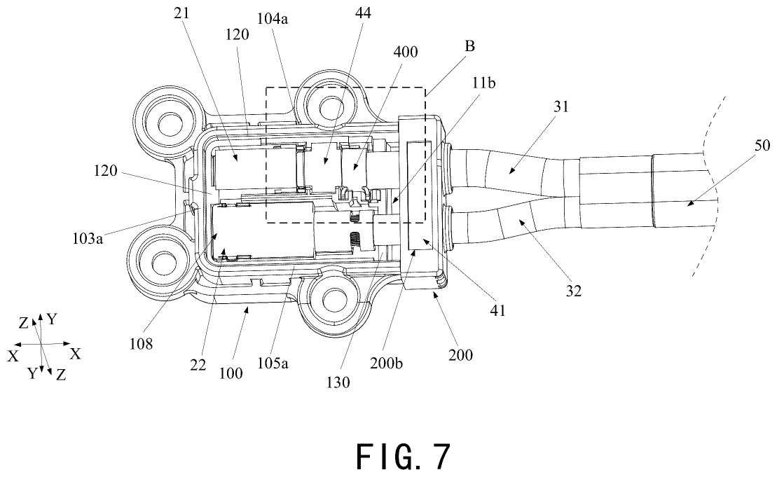

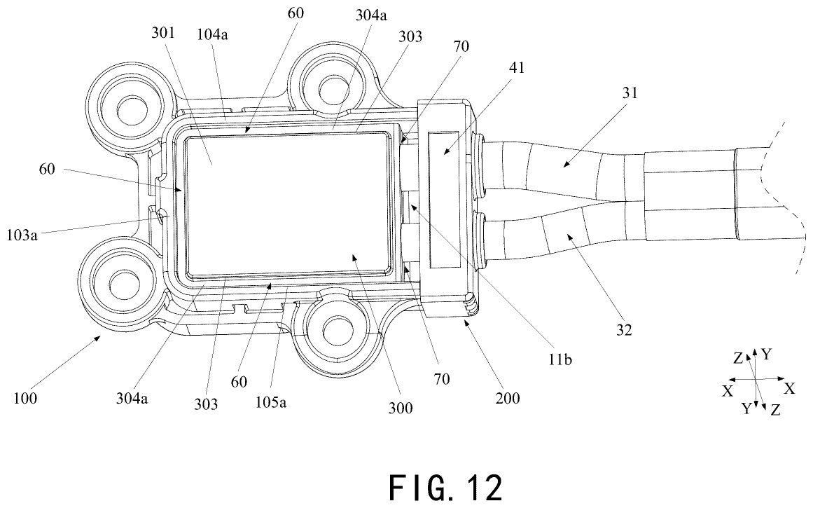

FIG. 7 is another perspective view of the electrical connector 1 of FIG. 1 with the top cover 300 of the housing 10, the second glue 42, and the third glue 43 of the electrical connector 1 hidden. FIG. 9 is an enlarged view of the area B circled by dashed lines of FIG. 7. FIG. 12 is yet another perspective view of the electrical connector 1 of FIG. 1 with the second glue 42 and the third glue 43 of the electrical connector 1 hidden.

As shown in FIGS. 3 to 7 and 12, the housing 10 includes a plurality of walls enclosing a space 11. As shown in the illustrated example, the body 100 of the housing 10 includes a rear end 101 and a front end 102 opposite to each other in the longitudinal direction X-X, a first sidewall 103 at the front end 102, and a second sidewall 104, a third sidewall 105, and a bottom wall 106 extending between the rear end 101 and the front end 102. The second sidewall 104 and the third sidewall 105 are opposing to each other in the lateral direction Y-Y. The bottom wall 106 extends in the lateral direction Y-Y between the second sidewall 104 and the third sidewall 105. The first sidewall 103 connects the second sidewall 104, the third sidewall 105, and the bottom wall 106. The first sidewall 103, the second sidewall 104, the third sidewall 105, and the bottom wall 106 of the body 100 may form four of the plurality of walls of the housing 10. Further, the rear cap 200 may form one of the plurality of walls of the housing 10, and the top cover 300 may form another one of the plurality of walls of the housing 10. The first sidewall 103, the second sidewall 104, the third sidewall 105, and the bottom wall 106 of the body 100, the rear cap 200, and the top cover 300 enclose the space 11.

In some embodiments, the body 100 may include an attachment portion 12 protruding outwardly and a hole 13 formed in the attachment portion 12. With such a configuration, it is possible to reliably secure the electrical connector 1, for example, to a panel, using fasteners such as a screw or a pin.

The body 100, the rear cap 200, and the top cover 300 may be formed from any suitable material. For example, the body 100, the rear cap 200, and the top cover 300 may be formed from an insulative material. Examples of insulative materials that are suitable for forming the body 100, the rear cap 200, and the top cover 300 include, but are not limited to, plastic, nylon, liquid crystal polymer (LCP), polyphenylene sulfide (PPS), high temperature nylon or polyphenylene oxide (PPO) or polypropylene (PP).

With continuing reference to FIGS. 3 to 7 and 12, the space 11 is located within the body 100. The body 100 includes a rear opening 107 (FIG. 5) connecting to the space 11 at the rear end 101 to allow the cable 30 to extend into the space 11 through the rear opening 107.

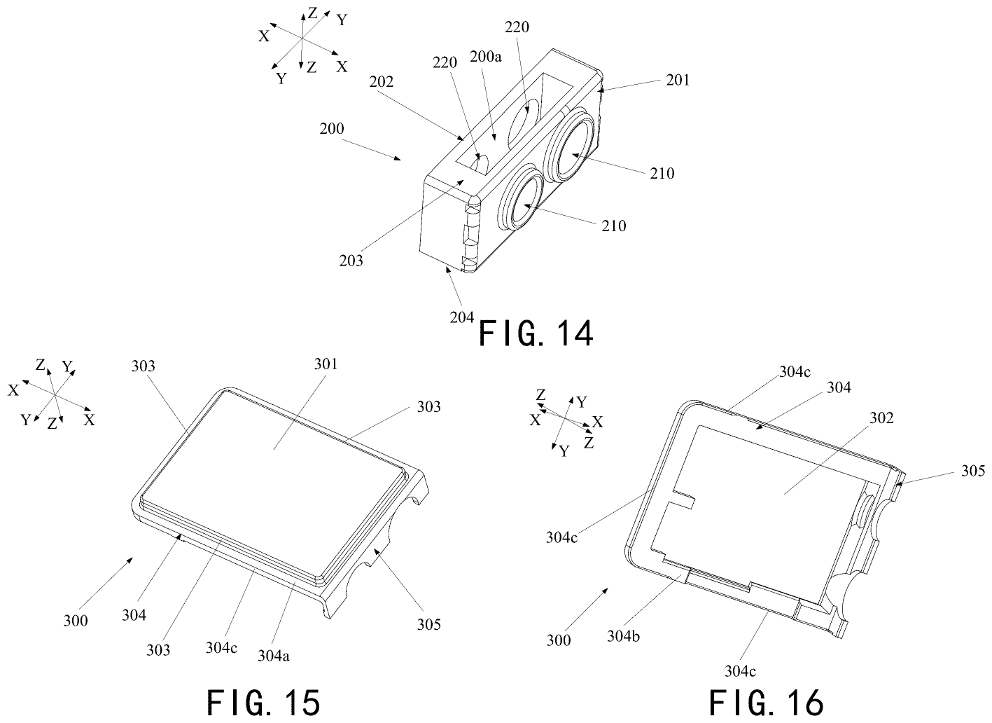

The rear cap 200 is mounted to the rear end 101 of the body 100 to close the rear opening 107. As described above, one of the plurality of walls of the housing 10 is formed by the rear cap 200. FIG. 14 is a perspective view of the rear cap 200. As shown in FIG. 14, the rear cap 200 (or referred to as “a first wall” of the housing 10) includes a cavity 200a formed therein, a first channel 210 extending from the cavity 200a through a rear portion 201 of the rear cap 200 to the exterior of the housing 10, and a second channel 220 extending from the cavity 200a through a front portion 202 of the rear cap 200 to the space 11.

As shown in FIGS. 1 to 5, 7, and 11 to 12, the cable 30 includes the power cable 31 configured for transmitting power and the signal cable 32 configured for transmitting signals. Portions of the power cable 31 and the signal cable 32 extending outside of the housing 10 may be surrounded by the same jacket 50. It should be appreciated that the portions of the power cable 31 and the signal cable 32 extending outside of the housing 10 may each be surrounded by a separate jacket, or may be devoid of a jacket.

The power cable 31 includes a wire 33 and a sheath 34 surrounding the wire 33. Although the power cable 31 is shown with four wires 33, it should be appreciated that the present application is not intended to be limited thereto and the power cable 31 may include any suitable number of wires. A portion of the sheath 34 at an end 31a of the power cable 31 is removed to allow the wires 33 to extend beyond an end 34a of the sheath 34. The wire 33 may include a conductor 33a and an insulator 33b surrounding the conductor. A portion of the insulator 33b corresponding to a connecting portion between the conductor 33a and the power module 21 is removed. This enables the power cable 31 to be ready for a connection to the power module 21.

Similar to the power cable 31, the signal cable 32 includes a wire 35 and a sheath 36 surrounding the wire 35. Although the signal cable 32 is shown with two wires 35, the present application is not intended to be limited thereto and the signal cable 32 may include any suitable number of wires. A portion of the sheath 36 at an end 32a of the signal cable 32 is removed to allow the wire 35 to extend beyond the end 36a of the sheath 36. The wire 35 may include a conductor 35a and an insulator 35b surrounding the conductor. A portion of the insulator 35b corresponding to a connecting portion between the conductor 35a and the signal module 22 is removed. This enables the signal cable 32 to be ready for a connection to the signal module 22. In some embodiments, the signal cable 32 can include a shielding casing disposed at the end 36a of the sheath 36.

The rear cap 200 is shown in FIG. 14 as including two first channels 210 corresponding to the power cable 31 and the signal cable 32 of the cable 30, respectively, thereby allowing the power cable 31 and the signal cable 32 to extend into the cavity 200a from the exterior of the housing 10 via the corresponding first channels 210, respectively. Further, the rear cap 200 is also shown in FIG. 14 as including two second channels 220 corresponding to the power cable 31 and the signal cable 32 of the cable 30, respectively, thereby allowing the power cable 31 and the signal cable 32 to extend into the space 11 from the cavity 200a via the corresponding second channels 220, respectively. It should be appreciated that the present application is not intended to be limited thereto and that the number of first channel 210 and second channel 220 may be one or more than two.

As shown in FIGS. 2 to 9, the module 20 includes the power module 21 configured for transmitting power and the signal module 22 configured for transmitting signals.

The power module 21 may include a body 21a and a power terminal held by the body 21a. The power terminal may be formed from a conductive material. The power terminal may include a first end, a second end 21b opposite to the first end, and an intermediate portion extending between the first end and the second end. The first end of the power terminal is configured to be connected with the conductor 33a of a corresponding wire 33 of the power cable 31. The second end 21b of the power terminal may be configured to be mounted to a circuit board such as a motherboard of an automotive LIDAR. As shown in FIGS. 2 and 4 to 7, when the power module 21 is mounted to the housing 10, the body 21a is located in the space 11 and the second end 21b extends through the bottom wall 106 of the body 100 to the exterior of the body 100 so as to be mounted to a circuit board. It should be appreciated that the present application is not intended to be limited thereto, and in some embodiments, the power module 21 may be located entirely in the space 11. For example, the power module 21 may be at least partially disposed in the space 11.

The signal module 22 may include a body 22a and a signal terminal held by the body 22a. The signal terminal may be formed from a conductive material. The signal terminal may include a first end, a second end 22b opposite to the first end, and an intermediate portion extending between the first end and the second end. The first end of the signal terminal is configured to be connected with the conductor 35a of a corresponding wire 35 of the signal cable 32. The second end 22b of the signal terminal may be configured to be mounted to a circuit board such as a motherboard of an automotive LIDAR. As shown in FIGS. 2 and 4 to 7, when the signal module 22 is mounted to the housing 10, the body 22a is located in the space 11 and the second end 22b extends through the bottom wall 106 of the body 100 to the exterior of the body 100 so as to be mounted to a circuit board. It should be appreciated that the present application is not intended to be limited thereto, and in some embodiments, the signal module 22 may be located entirely in the space 11. For example, the signal module 22 may be at least partially disposed in the space 11.

As shown in FIG. 4, the cable 30 extends into the space 11 from the exterior of the housing 10 through the first channel 210, the cavity 200a, and the second channel 220 of the rear cap 200, and is connected to the module 20 at an end thereof. As shown in the illustrated example, the power cable 31 extends into the space 11 from the exterior of the housing 10 through the corresponding first channel 210, the cavity 200a, and the corresponding second channel 220 of the rear cap 200, and is connected to the power module 21 at an end 31a thereof. The signal cable 32 extends into the space 11 from the exterior of the housing 10 through the corresponding first channel 210, the cavity 200a and the corresponding second channel 220 of the rear cap 200 and is connected to the signal module 22 at an end 32a thereof.

In some embodiments, the cable 30 may extend through the first channel 210, the cavity 200a, and the second channel 220 of the rear cap 200 before the rear cap 200 is mounted to the rear end 101 of the body 100. Optionally, the cable 30 may extend through the rear cap 200, the cavity 200a, and the second channel 220 of rear cap 200 after the rear cap 200 is mounted to the rear end 101 of the body 100.

In some embodiments, the cable 30 may be connected to the module 20 before the module 20 is mounted to the body 100. Optionally, the cable 30 may be connected to the module 20 after the module 20 is mounted to the body 100.

In some embodiments, the electrical connector 1 may include the first glue 41. As illustrated in FIGS. 1, 7, and 12, the first glue 41 is filled in the cavity 200a of the rear cap 200 and disposed around the portion of the cable 30 (e.g., the power cable 31 and the signal cable 32) located in the cavity 200a to fix the cable 30 relative to the rear cap 200. The first glue 41 may be applied after the rear cap 200 is mounted to the rear end 101 of the body 100 and the cable 30 is extended through the first channel 210, the cavity 200a, and the second channel 220 of the rear cap 200. Using the first glue 41 to fix the cable 30 relative to the rear cap 200 can improve the tensile strength of the cable 30 and the vibration resistance performance of the electrical connector 1, thereby improving the reliability of the electrical connector 1. Furthermore, using the first glue 41 to fix the cable 30 relative to the rear cap 200 can reduce the volume of the electrical connector 1 and can reduce the complexity of the manufacturing process and the manufacturing cost of the electrical connector 1 as compared to using the SR (strain relief) outer mold to fix the cable 30. The first glue 41 may also be referred to as “a fixing member” or “a fixing glue.”

The first glue 41 may be a UV glue, a silicone, an epoxy glue, or any other suitable type of glue. For example, the first glue 41 may be an underfill, such as a silicone underfill (e.g., a polysiloxane, a polydimethylsiloxane), an epoxy underfill (e.g., an epoxy resin, an epoxy acrylate), a urethane underfill (e.g., a urethane resin, a urethane acrylate), or an acrylate underfill (e.g., an acrylate monomer, an acrylate copolymer).

In some embodiments, the rear cap 200 may be mounted to the body 100 by any suitable means such as a snap-fit, a latching mechanism, a heat fusion weld, etc. For example, the body 100 may be provided with a snap-fit structure at the rear end 101 thereof and the rear cap 200 may be provided with a mating snap-fit structure. The snap-fit structure of the body 100 and the mating snap-fit structure of the rear cap 200 may cooperate with each other to reliably mount the rear cap 200 to the rear end 101 of the body 100.

As illustrated in FIGS. 4 to 6, when the rear cap 200 is mounted to the rear end 101 of the body 100, the front portion 202 of the rear cap 200 is located adjacent to the space 11, and a front face 202a of the front portion 202 of the rear cap 200 faces towards the space 11.

In some embodiments, the front portion 202 of the rear cap 200 includes a slot extending from the front face 202a through the front portion 202 to the cavity 200a. A portion 101a of the rear end 101 of the body 100 (FIG. 5) may be inserted into the slot. The first glue 41 may engage with the portion 101a of the rear end 101 of the body 100. As an example, the first glue 41 may extend into the slot of the front portion 202 to engage with the portion 101a of the rear end 101 of the body 100. As another example, the first surface 101b of the portion 101a of the rear end 101 of the body 100 may be exposed in the cavity 200a of the rear cap 200, and the first glue 41 may be disposed onto the first surface 101b. Engaging the first glue 41 with the aforementioned portion 101a of the rear end 101 of the body 100 can improve the connection strength between the rear cap 200 and the body 100 to improve the vibration resistance performance of the electrical connector 1. It should be appreciated that in some other embodiments, the rear cap 200 can be retained to the rear end 101 of the body 100 by engaging the first glue 41 with the aforementioned portion 101a of the rear end 101 of the body 100.

Optionally, in the embodiment where the first surface 101b of the aforementioned portion 101a of the rear end 101 of the body 100 is exposed in the cavity 200a of the rear cap 200, the aforementioned portion 101a of the rear end 101 of the body 100 may include a protrusion 101c protruding into the cavity 200a from the first surface 101b. The first glue 41 may be disposed onto the first surface 101b and engage with the protrusion 101c. In this way, the connection strength between the rear cap 200 and the body 100 can be further improved. Furthermore, the deformation of the first glue 41 when the cable 30 is pulled can be suppressed, thereby further improving the tensile strength of the cable 30. As an example, the protrusion 101c can be configured as a barb as shown.

Optionally or additionally, in the embodiment where the first surface 101b of the aforementioned portion 101a of the rear end 101 of the body 100 is exposed in the cavity 200a of the rear cap 200, the aforementioned portion 101a of the rear end 101 of the body 100 may include a recess 101d recessed into the aforementioned portion 101a from the first surface 101b. The first glue 41 may be disposed onto the first surface 101b and be filled into the recess 101d. In this way, the connection strength between the rear cap 200 and the body 100 can be further improved. In addition, the deformation of the first glue 41 when the cable 30 is pulled can be suppressed, thereby further improving the tensile strength of the cable 30.

In some embodiments, as illustrated in FIG. 4, the portion of the cable 30 located in the cavity 200a may extend in the longitudinal direction X-X. The rear cap 200 may include an opening 200b extending into the cavity 200a from the exterior of the housing 10 through the side portion 203 of the rear cap 200 in the lateral direction Y-Y perpendicular to the longitudinal direction X-X to allow the first glue 41 to be filled into the cavity 200a via the opening 200b. With such a configuration, it is possible to facilitate filling the first glue 41 into the cavity 200a and disposing the same around the portion of the cable 30 located in the cavity 200a. In addition, the opening 200b can be used as an inspection window to facilitate inspection of the filling of the first glue 41 in the cavity 200a.

In some embodiments, the rear portion 201 and the front portion 202 of the rear cap 200 may be opposing to each other and spaced apart from each other by the cavity 200a in the longitudinal direction X-X, and the side portion 203 connects the rear portion 201 and the front portion 202. The first channel 210 and the second channel 220 may each extend in the longitudinal direction X-X. The cross-section of the cavity 200a perpendicular to the longitudinal direction X-X may be larger than the cross-section of the first channel 210 perpendicular to the longitudinal direction X-X, and may be larger than the cross-section of the second channel 220 perpendicular to the longitudinal direction X-X. With such a configuration, it is possible to reliably engage the first glue 41 with the inner walls of the cavity 200a, thereby increasing the tensile strength of the cable 30. In some examples, the first channel 210 and the second channel 220 are aligned with each other in the longitudinal direction X-X. It should be appreciated that the present application is not intended to be limited thereto, and that the first channel 210 and the second channel 220 may be partially or completely offset from each other in the longitudinal direction X-X.

Optionally or additionally, in the embodiment where the first surface 101b of the aforementioned portion 101a of the rear end 101 of the body 100 is exposed in the cavity 200a of the rear cap 200, the first surface 101b of the aforementioned portion 101a of the rear end 101 of the body 100 may be exposed in the cavity 200a on the side of the portion of the cable 30 facing away from the opening 200b. The first glue 41 may be disposed onto and engage with the first surface 101b. As illustrated in FIGS. 5 and 6, the rear cap 200 may further include a bottom portion 204, the bottom portion 204 and the side portion 203 are opposing to each other and spaced apart from each other by the cavity 200a in the lateral direction Y-Y. The bottom portion 204 may include a top face 204a facing towards the cavity 200a and a groove 204b recessed into the bottom portion 204 from the top face 204a and connecting to the slot of the front portion 202. The aforementioned portion 101a of the rear end 101 of the body 100 is inserted into the groove 204b via the slot of the front portion 202 of the rear cap 200, and the first surface 101b of the aforementioned portion 101a is flush with the top face 204a of the bottom portion 204. In some embodiments, as described above, the aforementioned portion 101a of the rear end 101 of the body 100 may include a protrusion 101c protruding into the cavity 200a from the first surface 101b. The first glue 41 may be disposed onto the first surface 101b and engage with the protrusion 101c. For example, the protrusion 101c may be configured as a barb. Optionally or additionally, in some embodiments, as described above, the aforementioned portion 101a of the rear end 101 of the body 100 may include a recess 101d recessed into the aforementioned portion 101a from the first surface 101b. The first glue 41 may be disposed onto the first surface 101b and be filled into the recess 101d. With at least one of these configurations, the connection strength between the rear cap 200 and the body 100 can be further improved. In addition, the deformation of the first glue 41 when the cable 30 is pulled can be suppressed, thereby further improving the tensile strength of the cable 30.

In some embodiments, the first glue 41 may form a seal in the cavity 200a of the rear cap 200 to block the communication of the second channel 220 of the rear cap 200 with the exterior of the housing 10 via the cavity 200a, the first channel 210, and the opening 200b.

As shown in FIGS. 3 to 7 and 12, the body 100 also includes a first side between the rear end 101 and the front end 102 and opened to form an opening communicating the space 11 with the exterior of the housing 10. It should be appreciated that in some other embodiments, the first side may be partially opened to form a top opening 108 communicating the space 11 with the exterior of the housing 10. For example, the body 100 may include the first side between the rear end 101 and the front end 102, and the top opening 108 communicating the space 11 with the exterior of the housing 10 at the first side. The body 100 also includes an edge portion defining the top opening 108. As illustrated in FIGS. 6 and 12, the top opening 108 is defined by an edge portion 103a of the first sidewall 103, an edge portion 104a of the second sidewall 104, and an edge portion 105a of the third sidewall 105 of the body 100. The bottom wall 106 of the body 100 is opposing to the top opening 108 in the vertical direction Z-Z.

FIGS. 15 and 16 illustrate in detail the top cover 300 of the housing 10. As shown in FIGS. 15 and 16, the top cover 300 includes a top face 301, a bottom face 302 opposite to the top face 301, a side face 303 extending between the top face 301 and the bottom face 302, and a flange 304 extending outwardly beyond the side face 303. The flange 304 may extend either from the bottom face 302 or the side face 303. The flange 304 includes a top face 304a, a bottom face 304b opposite to the top face 304a, and a side face 304c extending between the top face 304a and the bottom face 304b. The top face 304a and the top face 301 face towards the same direction, and the bottom face 304b and the bottom face 302 face towards the same direction. The top face 304a is lower than the top face 301.

As shown in FIGS. 3, 7, 12, and 13, the top cover 300 is disposed in the top opening 108 of the body 100 to close the top opening 108. As described above, one of the plurality of walls of the housing 10 is formed by the top cover 300. The bottom face 302 and the bottom face 304b of the top cover 300 face towards the space 11. The edge portion 103a of the first sidewall 103, the edge portion 104a of the second sidewall 104, and the edge portion 105a of the third sidewall 105 of the body 100 form a groove 60 with the side face 303 and the top face 304a of the top cover 300. The side face 304c may engage with the edge portions or may be immediately adjacent to the edge portions.

In some embodiments, the electrical connector 1 may include the second glue 42 filled in the groove 60 to provide a seal. For example, the second glue 42 can block the communication from the space 11 to the exterior of the housing 10 via a gap between the top cover 300 and the edge portions (the edge portion 103a of the first sidewall 103, the edge portion 104a of the second sidewall 104, and the edge portion 105a of the third sidewall 105) of the body 100 defining the top opening 108. With such a configuration, it is possible to improve the sealing performance of the electrical connector 1. In addition, the reliability of the connection between the top cover 300 and the body 100 can be improved by such a configuration.

The second glue 42 may be a UV glue, a silicone, an epoxy glue, or any other suitable type of glue. For example, the second glue 42 may be an underfill, such as a silicone underfill (e.g., a polysiloxane, a polydimethylsiloxane), an epoxy underfill (e.g., an epoxy resin, an epoxy acrylate), a urethane underfill (e.g., a urethane resin, a urethane acrylate), or an acrylate underfill (e.g., an acrylate monomer, an acrylate copolymer).

In some embodiments, as illustrated in FIGS. 8 and 9, the body 100 may include a latch 109 extending into the space 11 from the bottom wall 106. The top cover 300 may include a corresponding engagement feature provided at the bottom face 302. When the top cover 300 is disposed in the top opening 108 of the body 100, the latch 109 of the body 100 may engage with the corresponding engagement feature of the top cover 300 to fix the top cover 300 in the top opening 108. It should be appreciated that the present application is not intended to be limited thereto, and that the top cover 300 may be fixed in the top opening 108 by any suitable securing mechanism or feature. For example, in some other embodiments, the top cover 300 may be fixed in the top opening 108 by the second glue 42 alone.

In some embodiments, as shown in FIGS. 6 to 9 and 12 to 13, the body 100 also includes a flange 120 protruding into the top opening 108. As one example, the flange 120 may protrude into the top opening 108 from the first sidewall 103, the second sidewall 104, and the third sidewall 105. As another example, the flange 120 may protrude into the top opening 108 from the bottom wall 106. As illustrated in FIG. 13, the bottom face 304b of the flange 304 of the top cover 300 is supported on the flange 120 of the body 100. With such a configuration, it is possible to form a labyrinth type seal at a position of the groove 60, thereby further improving the sealing performance of the electrical connector 1. Optionally or additionally, the body 100 can also be formed to support the top cover 300 in the top opening 108 by any other suitable structure.

In some embodiments, as shown in FIGS. 6 to 9 and 12, the body 100 may also include a rib 130 protruding into the space 11 from the bottom wall 106. The rib 130 divides the space 11 into a first space 11a between the rear end 101 (or the rear cap 200) and the rib 130 and a second space 11b between the rib 130 and the front end 102 (or the first sidewall 103). The module 20 (e.g., the power module 21 and the signal module 22) may be located in the second space 11b, and the cable 30 extends into the second space 11b from the exterior of the housing 10 through the rear cap 200 and the first space 11a. As illustrated in FIG. 12, the top cover 300 is disposed above the second space 11b to separate the second space 11b from the exterior of the body 100. In addition, the top cover 300 engages with the ribs 130 and, together with the rib 130, separates the second space 11b from the first space 11a.

The electrical connector I may also include the third glue 43 filled in the first space 1 la to provide a seal. For example, the third glue 43 can block the communication from the second space 11b to the exterior of the housing 10 via the seam between the top cover 300 and the rib 130 and the first space 11a. With such a configuration, the sealing performance of the electrical connector I can be improved. In addition, the reliability of the connection between the top cover 300 and the body 100 can be improved by such a configuration.

The third glue 43 may be a UV glue, a silicone, an epoxy glue, or any other suitable type of glue. For example, the third glue 43 may be an underfill, such as a silicone underfill (e.g., a polysiloxane, a polydimethylsiloxane), an epoxy underfill (e.g., an epoxy resin, an epoxy acrylate), a urethane underfill (e.g., a urethane resin, a urethane acrylate), or an acrylate underfill (e.g., an acrylate monomer, an acrylate copolymer).

In some embodiments, as shown in FIG. 12, the groove 60 can extend to and connect to the first space 11a to allow the second glue 42 and the third glue 43 to be applied integrally. For example, the second glue 42 and the third glue 43 can be applied by a single glue dropping process and be formed as one piece. With such a configuration, the sealing performance of the electrical connector I can be further improved. In addition, the reliability of the connection between the top cover 300 and the body 100 can be further improved by such a configuration.

As an example, as shown in FIGS. 15 and 16, the top cover 300 may include a rear flange 305 extending from the bottom face 302 or the flange 304 downwardly towards the rib 130 of the body 100. The rear flange 305 engages with the rib 130. A passageway 70 may be formed at the engaging portions of the rear flange 305 and the rib 130 (for example, as shown, the rear flange 305 and the rib 130 each define a half of each passageway 70), and the cable 30 extends into the second space 11b through the passageway 70. The third glue 43 can block the communication from the second space 11b to the exterior of the housing 10 via the passageway 70. The electrical connector 1 is shown in the figures as including two passageways 70 corresponding to the power cable 31 and the signal cable 32 of the cable 30, respectively, thereby allowing the power cable 31 and the signal cable 32 to extend into the second space 11b through the passageway 70, respectively. It should be appreciated that the present application is not intended to be limited thereto and that the number of passageways 70 may be one or more than two. It should also be appreciated that in some other examples, the passageway 70 may be formed in the rib 130.

In some embodiments, as shown in FIGS. 3 to 5, 8, and 11 and as described above, the power cable 31 is connected to the power module 21 at the end 31a thereof. As shown in the illustrated example, a portion of the sheath 34 of the power cable 31 at the end 31a thereof is removed to allow the wire 33 to extend beyond the end 34a of the sheath 34. The end 34a of the sheath 34 is located in the space 11 and in FIGS. 3 to 5, 8, and 11, is located in the second space 11b of the space 11. If the end 34a of the sheath 34 is not scaled, water vapor may enter the second space 11b along the interior of the sheath 34, such as in the case where there is a breakage in the sheath 34 of the portion of the power cable 31 that is outside of the housing 10 of the electrical connector 1, or in the case where an end of the sheath 34 opposite to the end 34a is not scaled. In order to reduce the risk of this, the electrical connector 1 may include the fourth glue 44 disposed around the end 34a of the sheath 34 in the space 11 (in the second space 11b) and forming a seal at the end 34a of the sheath 34. For example, the fourth glue 44 can block the communication from the second space 11b to the exterior of the housing 10 via the interior of the sheath 34. With such a configuration, the sealing performance of the electrical connector 1 can be improved. In some embodiments, similar to the power cable 31, a glue may be disposed at the end 36a of the sheath 36 of the signal cable 32 to form a seal.

The fourth glue 44 may be a UV glue, a silicone, an epoxy glue, or any other suitable type of glue. For example, the fourth glue 44 may be an underfill, such as a silicone underfill (e.g., a polysiloxane, a polydimethylsiloxane), an epoxy underfill (e.g., an epoxy resin, an epoxy acrylate), a urethane underfill (e.g., a urethane resin, a urethane acrylate), or an acrylate underfill (e.g., an acrylate monomer, an acrylate copolymer).

In some embodiments, as illustrated in FIG. 8, the body 100 may include a chamber 140 formed around the end 34a of the sheath 34 of the power cable 31 in the space 11, and the fourth glue 44 is filled in the chamber 140. With such a configuration, it is possible to facilitate the application of the fourth glue 44.

In some embodiments, as shown in FIGS. 3, 7, and 9, the electrical connector 1 may include a hoop 400. The hoop 400 is mounted on the sheath 34 of the power cable 31 and fixes the power cable 31 in the space 11 (in the second space 11b). With such a configuration, in one aspect, by fixing the power cable 31, the application of the fourth glue 44 can be facilitated and the risk of any displacement of the fourth glue 44 due to the shaking of the power cable 31 can be reduced; in another aspect, the tensile strength of the power cable 31 can be increased, thereby improving the vibration resistance performance; and in yet another aspect, by mounting the hoop 400 to the sheath 34 of the power cable 31, the sheath 34 can be tightened, thereby further enhancing the sealing. These can improve the reliability of the electrical connector 1. The hoop 400 can be utilized to fix the power cable 31 in the space 11 (in the second chamber portion 11b) before applying the fourth glue 44.

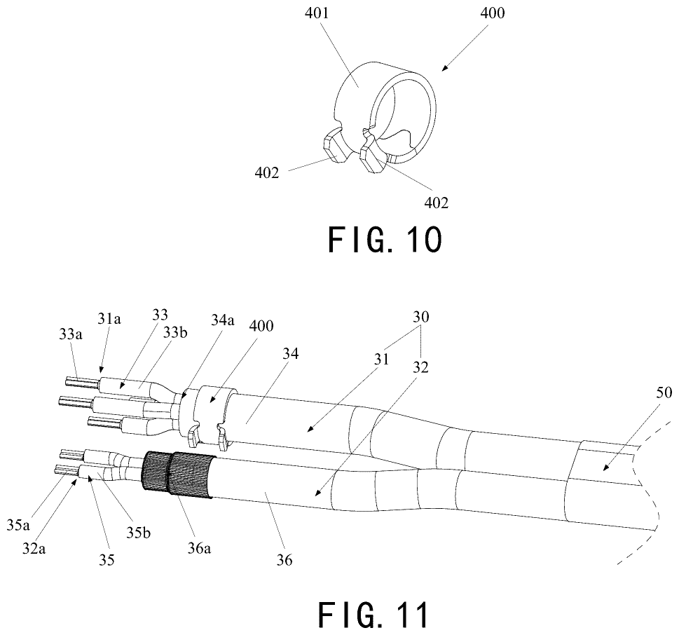

As illustrated in FIGS. 10 and 11, the hoop 400 includes an annular body 401 mounted to the sheath 34 of the power cable 31 and a tab 402 extending outwardly from the annular body 401. As illustrated in FIGS. 6 and 7, the body 10 may include a receiving area 150 formed in the space 11, and the tab 402 of the hoop 400 is received in the receiving area 150 to fix the first cable 31 in the space 11. For example, the hoop 400 may be formed from a metallic material. It should be appreciated that the hoop 400 may be in any other suitable form.

In some other embodiments, similar to the power cable 31, a hoop may be provided for the signal cable 32.

With at least one of the aforementioned configurations, the reliability of the electrical connector 1 can be improved.

Although specific configurations of the electrical connector 1 are described above in connection with the examples where the electrical connector 1 is a connector for Ethernet connection, it should be appreciated that the electrical connector 1 may be any suitable type of electrical connector and may be used in any other application.

It should be appreciated that the aforementioned configurations may be used alone or in any suitable combination. The preceding summary is provided by way of illustrations and is not meant to be limiting.

As an example, although the rear cap 200 is described above as a member separated from the body 100 and mounted to the body 100, it should be appreciated that the rear cap 200 may be integrally formed with the body 100. For example, the rear cap 200 is one of the plurality of walls of the body 100. In this case, the rear cap 200 may still be formed with the aforementioned cavity 200a, the first channel 210, the second channel 220, and the opening 200b, and protrusions and recesses similar to the protrusions 101c and the recesses 101d may be formed on the inner walls of the cavity 200a of the rear cap 200 to provide the various advantages described above.

As another example, the top cover 300 may be used individually to cooperate with the body 100 to provide the various advantages described above. Thus, the present application also provide an electrical connector including: a housing including: a body including a plurality of walls enclosing an space, an opening communicating the space with an exterior of the housing at a first side of the body, and an edge portion defining the opening; and a top cover including a top face, a bottom face opposite to the top face, a side face extending between the top face and the bottom face, and a flange extending outwardly beyond the side face, the flange including a top face and a bottom face opposite to the top face, the top face lower than the top face; an module at least partially disposed in the space; and a cable extending into the space from the exterior of the housing through the rear cap of the plurality of walls, and connected to the module at an end thereof. The top cover is disposed in the opening of the body to close the opening, with the bottom face and the bottom face facing towards the space, and the edge portion of the body forms a groove together with the side face and the top face of the top cover. The electrical connector further includes a first glue filled in the groove to form a seal.

As yet another example, the fourth glue 44 and the hoop 400 may be used individually or in combination to cooperate with the cable 30 to provide the various advantages described above. Thus, the present application also provides an electrical connector including: a housing including a plurality of walls enclosing a space; a module at least partially disposed in the space; a cable extending into the space from an exterior of the housing through a rear cap of the plurality of walls and connected to the module at an end thereof, the cable including a wire and a sheath surrounding the wire, a portion at the end of the cable removed to allow the wire to extend beyond the end of the sheath, the end of the sheath is located in the space; and a glue disposed around the end of the sheath in the space and forming a seal at the end of the sheath. The hoop may be arranged in a manner as described above.

Although the cavity 200a is shown as one, it should be appreciated that the cavity 200a may be multiple to correspond to the power cable 31 and the signal cable 32, respectively.

It should also be appreciated that the aforementioned directional and orientational relationships are exemplary and that the present application is not intended to be limited thereto.

As an example, although the portion of the cable 30 located in the cavity 200a is described above as extending in the longitudinal direction X-X, it should be appreciated that the portion of the cable 30 located in the cavity 200a may extend in any other suitable direction. For example, the portion may be curved in the cavity 200a.

As another example, although the opening 200b of the rear cap 200 is described above as extending through the side portion 203 of the rear cap 200 to the cavity 200a in the lateral direction Y-Y perpendicular to the longitudinal direction X-X, it should be appreciated that the opening 200b of the rear cap 200 may extend in any other direction perpendicular to the longitudinal direction X-X or in a direction not perpendicular to the longitudinal direction X-X.

As yet another example, although the rear portion 201 and the front portion 202 of the rear cap 200 are described above as being opposing to each other in the longitudinal direction X-X, it should be appreciated that the rear portion 201 and the front portion 202 of the rear cap 200 may be disposed in any other suitable orientational relationship.

Aspects of the present application relate to a method for manufacturing an electrical connector such as the aforementioned electrical connector 1.

In one aspect, the present application provides a method for manufacturing an electrical connector, which may include: providing the housing 10; disposing the module 20 (the power module 21 and the signal module 22) at least partially in the space 11; extending the cable 30 (the power cable 31 and the signal cable 32) into the space 11 from the exterior of the housing 10 through the first channel 210, the cavity 200a, and the second channel 220 of the first wall (for example, the rear cap 200) of the housing 10 and connecting the cable 30 to the module 20 at an end thereof; and filling the first glue 41 into the cavity 200a and disposing the first glue 41 around the portion of the cable 30 located in the cavity 200a to fix the cable 30 relative to the rear cap 200.

In some embodiments, the first wall of the housing 10 is formed by the rear cap 200. In this case, the method may also include mounting the rear cap 200 to the rear end 101 of the body 100 to close the rear opening 107.

In some embodiments, the method may further include inserting the portion 101a of the rear end 101 of the body 100 into the slot of the front portion 202 of the rear cap 200, and bringing the first glue 41 into engagement with the portion 101a of the rear end 101 of the body 100. In some embodiments, bringing the first glue 41 into engagement with the portion 101a of the rear end 101 includes disposing the first glue 41 onto the first surface 101b of the portion 101a of the rear end 101 of the body 100 and into engagement with the protrusion 101c. In another one of these embodiments, bringing the first glue 41 into engagement with the portion 101a of the rear end 101 includes disposing the first glue 41 onto the first surface 101b of the portion 101a of the rear end 101 of the body 100 and filling the first glue 41 in the recess 101d.

In some embodiments, filling the first glue 41 into the cavity 200a includes filling the first glue 41 into the cavity 200a via the opening 200b of the rear cap 200. In another one of these embodiments, the method may further include: inserting the portion 101a of the rear end 101 of the body 100 into the slot of the front portion 202 of the rear cap 200 such that the first surface 101b of the portion 101a is exposed in the cavity 200a on the side of the portion of the cable 30 facing away from the opening 200b; and disposed the first glue 41 onto and into engagement with the first surface 101b.

In some embodiments, inserting the portion 101a of the rear end 101 of the body 100 into the slot includes inserting the portion 101a of the rear end 101 of the body 100 into the groove 204b of the bottom portion 204 through the slot, wherein the first surface 101b is flush with the top face 204a of the bottom portion 204.

In some embodiments, the method may further include: disposing the top cover 300 in the top opening 108 of the body 100 to close the top opening 108 with the bottom face 302 and the bottom face 304b of the top cover 300 facing towards the space 11, and the aforementioned edge portion of the body 100 forming the groove 60 together with the side face 303 and the top face 304a of the top cover 300; and filling the second glue 42 into the groove 60 to provide the aforementioned seal.

In some embodiments, disposing the top cover 300 in the top opening 108 of the body 100 includes disposing the bottom face 304b of the flange 304 of the top cover 300 on the flange 120 of the body 100.

In some embodiments, the method may further include filling the third glue 43 into the first space 11a of the space 11 of the housing 10 to provide the aforementioned seal.

In some embodiments, the method may further include applying the second glue 42 and the third glue 43 integrally.

In some embodiments, the method may further include: removing a portion of the sheath 34 at the end 31a of the power cable 31 to allow the wire 33 to extend beyond the end 34a of the sheath 34, wherein the end 34a of the sheath 34 is located in the space 11; and disposing the fourth glue 44 around the end 34a of the sheath 34 in the space 11 and forming the aforementioned seal at the end 34a of the sheath 34. In some embodiments, the method may further include, before disposing the fourth glue, mounting the hoop 400 on the sheath 34 of the power cable 31 and fixing the first cable 30 in the space 11 by the hoop 400. It should be appreciated that a similar method may be performed for the signal cable 32.

It should be appreciated that the aforementioned methods may be used individually or in any suitable combination. The preceding summary is provided by way of illustrations and is not meant to be limiting.

As an example, the manufacturing method in connection with the top cover 300 may be used individually to provide the various advantages described above. Thus, the present application also provides a method for manufacturing an electrical connector including: providing a housing including: a body including a plurality of walls enclosing a space, an opening communicating the space with an exterior of the housing at a first side of the body, and an edge portion defining the opening; and a top cover including a top face, a bottom face opposite to the top face, a side face extending between the top face and the bottom face, and a flange extending outwardly beyond the side face, the flange including a top face and a bottom face opposite to the top face, the top face lower than the top face; disposing the module at least partially in the space; extending a cable into the space from the exterior of the housing through a first wall of the plurality of walls, and connecting the cable to the module at the end thereof; disposing the top cover in the opening of the body to close the opening, with the bottom face and the bottom face facing towards the space, and with the edge portion of the body forming a groove together with the side face and the top face of the top cover; and filling a first glue into the groove to form a seal.

As another example, the manufacturing method in connection with the fourth glue 44 and the hoop 400 may be used individually to provide the various advantages described above. Thus, the present application also provides a method for manufacturing an electrical connector including: providing a housing including a plurality of walls enclosing a space; disposing a module at least partially within the space; extending a cable into the space from an exterior of the housing through a first wall of the plurality of walls and connecting the cable to the module at an end thereof, wherein the cable includes a wire and a sheath surrounding the wire, a portion of the sheath at the end of the cable is removed such that the wire extends beyond the end of the sheath, the end of the sheath is located in the space; and disposing the first glue around the end of the sheath in the space to form a seal at the end of the sheath. The hoop may be arranged in a manner as described above.

The electrical connector manufactured according to any of the above methods presents high reliability.

It should be appreciated that the steps in these methods are capable of being performed in any suitable order and are not limited to the order as described.

### EXAMPLES

In an example, an electrical connector may comprise a housing comprising a plurality of walls enclosing a space, a first wall of the plurality of walls comprising a cavity formed therein, a first channel extending from the cavity through a rear portion of the first wall to an exterior of the housing, and a second channel extending from the cavity through a front portion of the first wall to the space; a module at least partially disposed in the space; a cable extending into the space from the exterior of the housing through the first channel, the cavity, and the second channel of the first wall, and connected to the module at an end thereof; and a first glue filled in the cavity and disposed around a portion of the cable located in the cavity to fix the cable relative to the first wall.

Such an electrical connector optionally may include one or more of the following features of characteristics:
the housing comprises at least: a body, the space located within the body, and the body comprising a rear end and a rear opening connecting to the space at the rear end; and a rear cap mounted to the rear end of the body to close the rear opening, the first wall of the housing formed by the rear cap.
the front portion of the first wall comprises a front face facing towards the space and a slot extending from the front face through the front portion to the cavity; and a portion of the rear end of the body is inserted into the slot and the first glue engages with the portion of the rear end.
the portion of the rear end of the body comprises a first surface exposed in the cavity and a protrusion protruding into the cavity from the first surface; and the first glue is disposed onto the first surface and engages with the protrusion.
the protrusion is configured as a barb.
the portion of the rear end of the body comprises a first surface exposed in the cavity and a recess recessed into the portion from the first surface; and the first glue is disposed onto the first surface and is filled into the recess.
the portion of the cable located in the cavity extends in a first direction; and the first wall comprises an opening extending from the exterior of the housing through a side portion of the first wall to the cavity in a second direction perpendicular to the first direction to allow the first glue to be filled into the cavity via the opening.
the rear portion and the front portion of the first wall are opposing to and spaced apart from each other by the cavity in the first direction, and the side portion connects the rear portion and the front portion.
the front portion of the first wall comprises a front face facing towards the space and a slot extending into the cavity from the front face through the front portion; a portion of the rear end of the body is inserted into the slot and comprises a first surface exposed in the cavity on a side of the portion of the cable facing away from the opening; and the first glue is disposed onto the first surface and engages with the first surface.
the first wall further comprises a bottom portion, the bottom portion and the side portion are opposing to and spaced apart from each other by the cavity in the second direction; the bottom portion comprises a top face facing towards the dispensing chamber and a groove recessed into the bottom portion from the top face and connecting to the slot; and the portion of the rear end of the body is inserted into the groove through the slot and the first surface is flush with the top face.
the portion of the rear end of the body further comprises a protrusion protruding into the cavity from the first surface, and the first glue is disposed onto the first surface and engages with the protrusion; and/or the portion of the rear end of the body further comprises a recess recessed into the portion from the first surface, and the first glue is disposed onto the first surface and filled into the recess.
the first channel and the second channel are aligned with each other in the first direction; and a cross-section of the cavity perpendicular to the first direction is larger than a cross-section of the first channel perpendicular to the first direction and is larger than a cross-section of the second channel perpendicular to the first direction.
the body further comprises a front end opposite to the rear end, a first side between the rear end and the front end, a top opening communicating the space with the exterior of the housing at the first side, and an edge portion defining the top opening; the housing further comprises a top cover comprising a top face, a bottom face opposite to the top face, a side face extending between the top face and the bottom face, and a flange extending outwardly beyond the side face, the flange comprising a top face and a bottom face opposite to the top face, the top face is lower than the top face; the top cover is disposed in the top opening of the body to close the top opening with the bottom face and the bottom face facing towards the space; the edge portion of the body forms a groove together with the side face and the top face of the top cover; and the electrical connector further comprises a second glue filled in the groove to provide a seal.
the body further comprises a flange protruding into the top opening, and the bottom face of the flange of the top cover is supported on the flange.
the body comprises a bottom wall opposing to the top opening and a rib protruding into the space from the bottom wall, the rib divides the space into a first space between the rear end and the rib and a second space between the rib and the front end; the module is located in the second space and the cable extends into the second space from the exterior of the housing through the first wall and the first space; the top cover is disposed over the second space to separate the second space from the exterior of the housing, and the top cover engages with the rib and, together with the rib, separates the second space from the first space; and the electrical connector further comprises a third glue filled in the first space to provide a seal.
the groove extends to and communicates with the first space to allow the second glue and the third glue to be applied integrally.
the top cover further comprises a rear flange extending downwardly towards the rib from the bottom face or the flange, and the rear flange engages with the rib; and a passageway is formed at engaging portions of the rear flange and the rib, and the cable extends into the second space through the passageway.
the cable comprises a first cable comprising a wire and a sheath surrounding the wire, a portion of the sheath at an end of the first cable is removed to allow the wire to extend beyond an end of the sheath, the end of the sheath is located in the space; and the electrical connector further comprises a fourth glue disposed in the space around the end of the sheath and forming a seal at the end of the sheath.
the housing comprises a chamber formed around the end of the sheath in the space, and the fourth glue is filled in the chamber.
the electrical connector further comprises a hoop mounted on the sheath of the first cable and fixing the first cable in the space.
the hoop comprises an annular body mounted on the sheath and a tab protruding outwardly from the annular body, the housing comprises a receiving area formed in the accommodating cavity, the tab is received in the receiving area to fix the first cable in the accommodating cavity.
the first cable is a power cable configured for transmitting power.

In another example, an electrical connector may comprise a housing, comprising: a body comprising a plurality of walls enclosing a space, an opening communicating the space with an exterior of the housing at a first side of the body, and an edge portion defining the opening; and a top cover comprising a top face, a bottom face opposite to the top face, a side face extending between the top face and the bottom face, and a flange extending outwardly beyond the side face, the flange comprising a top face and a bottom face opposite to the top face, the top face lower than the top face; a module at least partially disposed in the space; and a cable extending into the space from the exterior of the housing through a first wall of the plurality of walls, and connected to the module at an end thereof; wherein the top cover is disposed in the opening of the body to close the opening, with the bottom face and the bottom face facing towards the space, and with the edge portion of the body forming a groove together with the side face and the top face of the top cover; wherein the electrical connector further comprises a first glue filled in the groove to form a seal.

Such an electrical connector optionally may include one or more of the following features of characteristics:
the body further comprises a flange protruding into the opening and the bottom face of the flange of the top cover is supported on the flange.
the plurality of walls further comprises a second wall opposing to the first wall and a bottom wall extending between the first wall and the second wall, the bottom wall is opposing to the opening; the body further comprises a rib extending into the space from the bottom wall, the rib divides the space into a first space between the first wall and the rib and a second space between the rib and the second wall; the module is located in the second space and the cable extends into the second space from the exterior of the housing through the first wall and the first space; the top cover is disposed over the second space to separate the second space from the exterior of the housing, and the top cover engages with the rib and, together with the rib, separates the second space from the first space; and the electrical connector further comprises a second glue filled in the first space to provide a seal.
the groove extends into and communicates with the first space to allow the first glue and the second glue to be applied integrally.
the top cover further comprises a rear flange extending downwardly towards the rib from the bottom face or the flange, and the rear flange engages with the rib; and a passageway is formed at engaging portions of the rear flange and the rib, and the cable extends into the second space through the passageway.
the cable comprises a first cable comprising a wire and a sheath surrounding the wire, a portion of the sheath at an end of the first cable is removed to allow the wire to extend beyond an end of the sheath, the end of the sheath is located in the space; and the electrical connector further comprises a third glue disposed in the space around the end of the sheath and forming a seal at the end of the sheath.
the electrical connector further comprises a hoop mounted on the sheath of the first cable and fixing the first cable in the space; and/or the first cable is a power cable configured for transmitting power.
the first wall comprises a cavity formed in the first wall, a first channel extending from the cavity through a rear portion of the first wall to an exterior of the housing, and a second channel extending from the cavity through a front portion of the first wall to the space; the cable extends into the space from the exterior of the housing through the first channel, the cavity, and the second channel of the first wall; and a fourth glue filled in the cavity and disposed around a portion of the cable located in the cavity to fix the cable relative to the first wall.

In another example, an electrical connector may comprise a housing comprising a plurality of walls enclosing a space; a module at least partially disposed in the space; a cable extending into the space from an exterior of the housing through a first wall of the plurality of walls and connected to the module at an end thereof, the cable comprising a wire and a sheath surrounding the wire, a portion of the sheath at the end of the cable is removed to allow the wire to extend beyond an end of the sheath, the end of the sheath is located in the space; and a first glue disposed in the space around the end of the sheath and forming a seal at the end of the sheath.

Such an electrical connector optionally may include one or more of the following features of characteristics:
the housing comprises a chamber formed around the end of the sheath in the space, and the first glue is filled in the chamber; and/or the cable is a power cable configured for transmitting power.
the electrical connector further comprises a hoop mounted on the sheath of the cable and fixing the cable in the space.
the hoop comprises an annular body mounted on the sheath and a tab protruding outwardly from the annular body, the housing comprises a receiving area formed in the accommodating cavity, the tab is received in the receiving area to fix the cable in the accommodating cavity.
the cable comprises a power cable configured for transmitting power and a signal cable configured for transmitting a signal; the module comprises a power module configured for transmitting power and a signal module configured for transmitting a signal; and the power cable is connected to the power module and the signal cable is connected to the signal module.
the signal cable is configured for transmitting an Ethernet electrical signal; and/or portions of the power cable and the signal cable extending outside of the housing are surrounded by the same jacket.
the module comprises a conductive terminal comprising a first end and a second end opposite to the first end, the first end is connected to the cable, and the second end is configured to be mounted to a circuit board; and/or the housing further comprises an attachment portion protruding outwardly and a hole formed in the attachment portion.

In another example, a method for manufacturing an electrical connector may comprise providing a housing comprising a plurality of walls enclosing a space, a first wall of the plurality of walls comprising a cavity formed therein, a first channel extending from the cavity through a rear portion of the first wall to an exterior of the housing, and a second channel extending from the cavity through a front portion of the first wall to the space; disposing a module at least partially in the space; extending a cable into the space from the exterior of the housing through the first channel, the cavity, and the second channel of the first wall, and connecting the cable to the module at an end thereof; and filling a first glue in the cavity and disposing the first glue around a portion of the cable located in the cavity to fix the cable relative to the first wall.

Such a method for manufacturing an electrical connector optionally may include one or more of the following features of characteristics:
the housing comprises at least a body and a rear cap, the space is located within the body, and the body comprises a rear end and a rear opening connecting to the space at the rear end, the rear cap is configured to form the first wall of the housing; and the method further comprises mounting the rear cap to the rear end of the body to close the rear opening.
the front portion of the first wall comprises a front face facing towards the space and a slot extending from the front face through the front portion to the cavity; and the method further comprises inserting a portion of the rear end of the body into the slot and bringing the first glue into engagement with the portion of the rear end.
the portion of the rear end of the body comprises a first surface exposed in the cavity and a protrusion protruding into the cavity from the first surface; and bringing the first glue into engagement with the portion of the rear end comprises disposing the first glue onto the first surface and into engagement with the protrusion.
the portion of the rear end of the body comprises a first surface exposed in the cavity and a recess recessed into the portion from the first surface; and bringing the first glue into engagement with the portion of the rear end comprises disposing the first glue onto the first surface and filling the first glue into the recess.
the portion of the cable located in the cavity extends in a first direction, the first wall comprises an opening extending from the exterior of the housing through a side portion of the first wall to the cavity in a second direction perpendicular to the first direction to allow the first glue to be filled into the cavity via the opening; and filling the first glue in the cavity comprises filling the first glue into the cavity via the opening.
the rear portion and the front portion of the first wall are opposing to and spaced apart from each other by the cavity in the first direction, and the side portion connects the rear portion and the front portion; the front portion of the first wall comprises a front face facing towards the space and a slot extending to the cavity from the front face through the front portion; and the method further comprises: inserting a portion of the rear end of the body into the slot such that a first surface of the portion is exposed in the cavity on a side of the portion of the cable facing away from the opening; and disposing the first glue onto the first surface and into engagement with the first surface.
the first wall further comprises a bottom portion, the bottom portion and the side portion are opposing to and spaced apart from each other by the cavity in the second direction; the bottom portion comprising a top face facing towards the dispensing chamber and a groove recessed into the bottom portion from the top face and connecting to the slot; and inserting the portion of the rear end of the body into the slot comprises inserting the portion of the rear end of the body into the groove through the slot with the first surface flush with the top face.
the portion of the rear end of the body further comprises a protrusion protruding into the cavity from the first surface, and disposing the first glue onto the first surface and into engagement with the first surface comprises disposing the first glue onto the first surface and into engagement with the protrusion; and/or the portion of the rear end of the body further comprises a recess recessed into the portion from the first surface, and disposing the first glue onto the first surface and into engagement with the first surface comprises disposing the first glue onto the first surface and filling the first glue into the recess.
the body further comprises a front end opposite to the rear end, a first side between the rear end and the front end, a top opening communicating the space with the exterior of the housing at the first side, and an edge portion defining the top opening; and the housing further comprises a top cover comprising a top face, a bottom face opposite to the top face, a side face extending between the top face and the bottom face, and a flange extending outwardly beyond the side face, the flange comprises a top face and a bottom face opposite to the top face, the top face is lower than the top face; the method further comprises: disposing the top cover in the top opening of the body to close the top opening with the bottom face and the bottom face facing towards the space and with the edge portion of the body forming a groove together with the side face and the top face of the top cover; and filling a second glue in the groove to provide a seal.
the body further comprises a flange protruding into the top opening; and disposing the top cover in the top opening comprises disposing the bottom face of the flange of the top cover on the flange.
the body comprises a bottom wall opposing to the top opening and a rib protruding into the space from the bottom wall, the rib divides the space into a first space between the rear end and the rib and a second space between the rib and the front end; the module is located in the second space, and the cable extends into the second space from the exterior of the housing through the first wall and the first space; the top cover is disposed over the second space to separate the second space from the exterior of the housing, and the top cover engages with the rib and, together with the rib, separates the second space from the first space; and the method further comprises filling a third glue in the first space to provide a seal.
the groove extends to and communicates with the first space to allow the second glue and the third glue to be applied integrally; and the method further comprises applying the second glue and the third glue integrally.
the cable comprises a first cable comprising a wire and a sheath surrounding the wire; the method further comprises: removing a portion of the sheath at an end of the first cable to allow the wire to extend beyond an end of the sheath, wherein the end of the sheath is located in the space; and disposing a fourth glue in the space around the end of the sheath to form a seal at the end of the sheath.
the method further comprises before disposing the fourth glue, mounting a hoop onto the sheath of the first cable and fix the first cable in the space with the hoop; and/or the first cable is a power cable configured for transmitting power.

In another example, a method for manufacturing an electrical connector may comprise providing a housing, comprising: a body comprising a plurality of walls enclosing a space, an opening communicating the space with an exterior of the housing at a first side of the body, and an edge portion defining the opening; and a top cover comprising a top face, a bottom face opposite to the top face, a side face extending between the top face and the bottom face, and a flange extending outwardly beyond the side face, the flange comprising a top face and a bottom face opposite to the top face, the top face lower than the top face; disposing a module at least partially in the space; extending a cable into the space from the exterior of the housing through a first wall of the plurality of walls, and connecting the cable to the module at an end thereof; disposing the top cover in the opening of the body to close the opening, with the bottom face and the bottom face facing towards the space, and with the edge portion of the body forming a groove together with the side face and the top face of the top cover; and filling a first glue in the groove to form a seal.

Such a method for manufacturing an electrical connector optionally may include one or more of the following features of characteristics:
the body further comprises a flange protruding into the opening; and disposing the top cover in the opening comprises disposing the bottom face of the flange of the top cover on the flange.
the plurality of walls further comprises a second wall opposing to the first wall and a bottom wall extending between the first wall and the second wall, the bottom wall is opposing to the opening; the body further comprises a rib extending into the space from the bottom wall, the rib divides the space into a first space between the first wall and the rib and a second space between the rib and the second wall; the module is located in the second space and the cable extends into the second space from the exterior of the housing through the first wall and the first space; the top cover is disposed over the second space to separate the second space from the exterior of the housing, and the top cover engages with the rib and, together with the rib, separates the second space from the first space; and the method further comprises filling a second glue in the first space to provide a seal.
the groove extends to and communicates with the first space to allow the first glue and the second glue to be applied integrally; and the method further comprises applying the first glue and the second glue integrally.
the cable comprises a first cable comprising a wire and a sheath surrounding the wire; the method further comprises: removing a portion of the sheath at an end of the first cable to allow the wire to extend beyond an end of the sheath, wherein the end of the sheath is located in the space; and disposing a third glue in the space around the end of the sheath to form a seal at the end of the sheath.
the method further comprises: before applying the third glue, mounting a hoop onto the sheath of the first cable and fixing the first cable in the space with the hoop; and/or the first cable is a power cable configured for transmitting power.
the first wall comprises a cavity formed in the first wall, a first channel extending from the cavity through a rear portion of the first wall to an exterior of the housing, and a second channel extending from the cavity through a front portion of the first wall to the space; extending the cable into the space from the exterior of the housing through the first wall comprises extending the cable into the space from the exterior of the housing through the first channel, the cavity, and the second channel of the first wall; and the method further comprises filling a fourth glue in the cavity and disposing the fourth glue around a portion of the cable located in the cavity to fix the cable relative to the first wall.

In another example, a method for manufacturing an electrical connector may comprise providing a housing comprising a plurality of walls enclosing a space; disposing a module at least partially in the space; extending a cable extending into the space from an exterior of the housing through a first wall of the plurality of walls, and connecting the cable to the module at an end thereof, wherein the cable comprises a wire and a sheath surrounding the wire, a portion of the sheath at the end of the cable is removed to allow the wire to extend beyond an end of the sheath, the end of the sheath is located in the space; and disposing a first glue in the space around the end of the sheath to form a seal at the end of the sheath.

Such a method for manufacturing an electrical connector optionally may include one or more of the following features of characteristics:
before applying the first glue, mounting a hoop onto the sheath of the cable and fixing the cable in the space with the hoop.
the cable is a power cable configured for transmitting power.

In another example, an electrical connector may comprise a housing at least partially enclosing a space, the housing comprising an opening, connected to the space, at a top and a cap (e.g., 200) disposed at a rear of the housing, the cap comprising a cavity having first and second channels connected to the space; a first cable (e.g., 31) extending through the first channel of the cap into the space of the housing; a second cable extending through the second channel of the cap into the space of the housing; and a sealing material disposed in the cavity of the cap such that portions of the first and second cables extending through the first and second channels are fixedly disposed in the sealing material.

Such an electrical connector optionally may include one or more of the following features of characteristics:
the electrical connector may comprise a first module (e.g., 21) comprising a first end disposed in the space and connected to the first cable, and a second end extending out of the housing from a bottom of the housing and configured to mount to a circuit board; and a second module (e.g., 22) comprising a first end disposed in the space and connected to the second cable, and a second end extending out of the housing from the bottom of the housing and configured to mount to a circuit board.
the first module is a power module configured to supply power; and the second module is a signal module configured to transmit Ethernet signals.
the cap comprises a bottom having grooves and protrusions protruding into the cavity and engaging the sealing material.
the electrical connector may comprise a cover (e.g., 300) disposed at the top of the housing and substantially covering the opening at the top of the housing, wherein the sealing material comprises a first portion disposed around the cover so as to fill a groove between the cover and the housing.
the cover is separated from the cap by a first portion of the space of the housing; the sealing material comprises a second portion disposed in the first portion of the space of the housing; and portions of the first and second cables extending in the first portion of the space pass through and are held by the second portion of the sealing material.
the housing comprises a rib; the first portion of the space of the housing is between the rear of the housing and the rib; the space of the housing comprises a second portion between the rib and a front of the housing; the electrical connector comprises one or more modules disposed in the second portion of the space; and each of the one or more modules is a terminal subassembly.
the first cable comprises a sheath and a plurality of wires in the sheath, each of the plurality of wires comprising an end extending out of the sheath; the first module is connected to the first cable at the end extending out of the sheath; the housing comprises a chamber (e.g., 140) through which the ends of the plurality of wires extend to the first module; and the sealing material comprises a third portion disposed in the chamber of the housing such that the ends of the plurality of wires of the first cable are fixedly disposed in the third portion.
the sealing material comprises cured adhesive.
the electrical connector may comprise a hoop disposed adjacent the chamber of the housing and attached to the sheath of the first cable.

In another example, an electrical connector may comprise a housing comprising an opening at a rear and a plurality of attachment portions extending outwardly from a front and/or sides; a first module (e.g., 21) disposed in the housing, the first module comprising a plurality of first ends extending toward the rear of the housing and a plurality of second ends extending out of a bottom of the housing; and a second module (e.g., 22) disposed in the housing, the second module comprising a plurality of first ends extending toward the rear of the housing and a plurality of second ends extending out of the bottom of the housing.

Such an electrical connector optionally may include one or more of the following features of characteristics:
each of the plurality of attachment portions of the housing comprises a hole extending therethrough.
the plurality of attachment portions of the housing comprises a first pair of attachment portions extending outwardly from the front of the housing, and a second pair of attachment portions respectively extending outwardly from opposite sides of the housing.
the electrical connector may comprise a first cable (e.g., 31) attached to the plurality of first ends of the first module and extending out of the housing from the rear of the housing; and a second cable (e.g., 32) attached to the plurality of first ends of the second module and extending out of the housing from the rear of the housing, the second cable comprising a pair of signal wires.
the rear of the housing comprises a cap (e.g., 200) having a cavity through which the first and second cables extend; and the electrical connector comprises a sealing member (e.g., 41) disposed in the cavity of the cap and enclosing portions of the first and second cables extending therein.
the electrical connector may comprise a cover (e.g., 300) disposed at a top of the housing; and a second sealing member (e.g., 42) disposed between the housing and the cover.
the first cable comprises two or more wires; a hoop disposed around a sheath of the first cable; and a third sealing member (e.g., 43) disposed between the first module and the hoop.

In another example, a method for manufacturing an electrical connector may comprise providing a subassembly comprising a first module (e.g., 21) and a second module (e.g., 22), a rear cap (e.g., 200) of a housing, and first and second cables (e.g., 31, 32) extending through the rear cap of the housing into the housing, the rear cap of the housing comprising a cavity; providing adhesive into the cavity of the rear cap and around portions of the first and second cables extending through the cavity of the rear cap of the housing so as to form a seal between the housing and the first and second cables; positioning the first module and the second module in the housing; and affixing the rear cap to the housing.

Such a method for manufacturing an electrical connector optionally may include one or more of the following features of characteristics:
the method may comprise providing adhesive into a chamber (e.g., 140) inside the housing and around portions of wires of the first cable so as to form a seal between the housing and the first cable.
the method may comprise disposing a cover (e.g., 300) at a top of the housing; and providing adhesive around the cover and in gaps between the cover and the housing so as to form a seal between the housing and the cover.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10+d1 and 20+d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing at least partially enclosing a space, the housing comprising an opening, connected to the space, at a top and a cap disposed at a rear of the housing, the cap comprising a cavity having first and second channels connected to the space;
a first cable extending through the first channel of the cap into the space of the housing;
a second cable extending through the second channel of the cap into the space of the housing; and
a sealing material disposed in the cavity of the cap such that portions of the first and second cables extending through the first and second channels are fixedly disposed in the sealing material.

2. The electrical connector of claim 1, comprising:
a first module comprising a first end disposed in the space and connected to the first cable, and a second end extending out of the housing from a bottom of the housing and configured to mount to a circuit board; and
a second module comprising a first end disposed in the space and connected to the second cable, and a second end extending out of the housing from the bottom of the housing and configured to mount to a circuit board.

3. The electrical connector of claim 2, wherein:
the first module is a power module configured to supply power; and
the second module is a signal module configured to transmit Ethernet signals.

4. The electrical connector of claim 1, wherein:
the cap comprises a bottom having grooves and protrusions protruding into the cavity and engaging the sealing material.

5. The electrical connector of claim 1, comprising:
a cover disposed at the top of the housing and substantially covering the opening at the top of the housing,
wherein the sealing material comprises a first portion disposed around the cover so as to fill a groove between the cover and the housing.

6. The electrical connector of claim 5, wherein:
the cover is separated from the cap by a first portion of the space of the housing;
the sealing material comprises a second portion disposed in the first portion of the space of the housing; and
portions of the first and second cables extending in the first portion of the space pass through and are held by the second portion of the sealing material.

7. The electrical connector of claim 6, wherein:
the housing comprises a rib;
the first portion of the space of the housing is between the rear of the housing and the rib;
the space of the housing comprises a second portion between the rib and a front of the housing;
the electrical connector comprises one or more modules disposed in the second portion of the space; and
each of the one or more modules is a terminal subassembly.

8. The electrical connector of claim 2, wherein:
the first cable comprises a sheath and a plurality of wires in the sheath, each of the plurality of wires comprising an end extending out of the sheath;
the first module is connected to the first cable at the end extending out of the sheath;
the housing comprises a chamber through which the ends of the plurality of wires extend to the first module; and
the sealing material comprises a third portion disposed in the chamber of the housing such that the ends of the plurality of wires of the first cable are fixedly disposed in the third portion.

9. The electrical connector of claim 8, wherein:
the sealing material comprises cured adhesive.

10. The electrical connector of claim 8, comprising:
a hoop disposed adjacent the chamber of the housing and attached to the sheath of the first cable.

11. An electrical connector comprising:
a housing comprising an opening at a rear and a plurality of attachment portions extending outwardly from a front and/or sides;
a first module disposed in the housing, the first module comprising a plurality of first ends extending toward the rear of the housing and a plurality of second ends extending out of a bottom of the housing; and
a second module disposed in the housing, the second module comprising a plurality of first ends extending toward the rear of the housing and a plurality of second ends extending out of the bottom of the housing.

12. The electrical connector of claim 11, wherein:
each of the plurality of attachment portions of the housing comprises a hole extending therethrough.

13. The electrical connector of claim 11, wherein:
the plurality of attachment portions of the housing comprises a first pair of attachment portions extending outwardly from the front of the housing, and a second pair of attachment portions respectively extending outwardly from opposite sides of the housing.

14. The electrical connector of claim 11, comprising:
a first cable attached to the plurality of first ends of the first module and extending out of the housing from the rear of the housing; and
a second cable attached to the plurality of first ends of the second module and extending out of the housing from the rear of the housing, the second cable comprising a pair of signal wires.

15. The electrical connector of claim 14, wherein:
the rear of the housing comprises a cap having a cavity through which the first and second cables extend; and
the electrical connector comprises a sealing member disposed in the cavity of the cap and enclosing portions of the first and second cables extending therein.

16. The electrical connector of claim 15, comprising:
a cover disposed at a top of the housing; and
a second sealing member disposed between the housing and the cover.

17. The electrical connector of claim 16, wherein:
the first cable comprises two or more wires;
a hoop disposed around a sheath of the first cable; and
a third sealing member disposed between the first module and the hoop.

18. A method of manufacturing an electrical connector, comprising:
providing a subassembly comprising a first module and a second module, a rear cap of a housing, and first and second cables extending through the rear cap of the housing into the housing, the rear cap of the housing comprising a cavity;
providing adhesive into the cavity of the rear cap and around portions of the first and second cables extending through the cavity of the rear cap of the housing so as to form a seal between the housing and the first and second cables;
positioning the first module and the second module in the housing; and
affixing the rear cap to the housing.

19. The method of claim 18, comprising:
providing adhesive into a chamber inside the housing and around portions of wires of the first cable so as to form a seal between the housing and the first cable.

20. The method of claim 19, comprising:
disposing a cover at a top of the housing; and
providing adhesive around the cover and in gaps between the cover and the housing so as to form a seal between the housing and the cover.
